(19) United States
(12) Patent Application Publication
(10) Pub. No.: US 2026/0370570 A1
(43) Pub. Date: Nov. 19, 2026

(54) METHODS, DEVICES AND MEDIUM FOR COMMUNICATION

(71) Applicant: NEC Corporation, Tokyo (JP)

(72) Inventors: Peng GUAN, Beijing (CN); Zhen HE, Beijing (CN); Rao SHI, Beijing (CN); Gang WANG, Beijing (CN)

(73) Assignee: NEC Corporation, Tokyo (JP)

(21) Appl. No.: 19/148,027

(22) PCT Filed: Jan. 16, 2023
(86) PCT No.: PCT/CN2023/072467

§ 371 Date: Jul. 15, 2025

(51) Int. Cl. H04L 41/16; H04B 17/309

(52) U.S. Cl. CPC H04L 41/16; H04B 17/309

(57) ABSTRACT

Example embodiments of the present disclosure relate to a method of communication, comprising: receiving, at a terminal device, from a network device, a configuration for at least reporting information concerning a management of an artificial intelligence/machine learning (AI/ML) model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and transmitting, to the network device, the information based on the configuration.

### FIELDS

Example embodiments of the present disclosure generally relate to the field of communication techniques and in particular, to methods, devices, and medium for managing an artificial intelligence/machine learning (AI/ML) model.

### BACKGROUND

Several technologies have been proposed to improve communication performances. For example, communication devices may employ an AI/ML model to improve communication qualities. The AI/ML model can be applied to different scenarios to achieve better performances. Therefore, how to ensure accuracy of output of the AI/ML model is worth studying, in order to ensure satisfying communication performances.

### SUMMARY

In general, embodiments of the present disclosure provide methods, devices and computer storage medium for an AI/ML model.

In a first aspect, there is provided a terminal device comprising: a processor configured to cause the terminal device to: receive, from a network device, a configuration for at least reporting information concerning a management of an AI/ML model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and transmit, to the network device, the information based on the configuration.

In a second aspect, there is provided a network device comprising: a processor configured to cause the network device to: transmit, to a terminal device, a configuration for at least reporting information concerning a management of an AI/ML model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and receive, from the terminal device, the information based on the configuration.

In a third aspect, there is provided a terminal device comprising: a processor configured to cause the terminal device to: receive, from a network device, a first indication to select at least one of a first component of an AI/ML model or a second component of the AI/ML model, wherein the first component is used by the terminal device, and the second component is used by the network device; and in response to the first indication, determine at least one of the following: one or more results associated with a measurement, a terminal component to be used as the first component, or a network component to be used as the second component.

In a fourth aspect, there is provided a network device comprising: a processor configured to cause the network device to: transmit, to a terminal device, a first indication to select at least one of a first component of an AI/ML model or a second component of the AI/ML model, wherein the first component is used by the terminal device, and the second component is used by the network device.

In a fifth aspect, there is provided a communication method. The method comprises: receiving, at a terminal device, from a network device, a configuration for at least reporting information concerning a management of an AI/ML model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and transmitting, to the network device, the information based on the configuration.

In a sixth aspect, there is provided a communication method. The method comprises: transmitting, at a network device, to a terminal device, a configuration for at least reporting information concerning a management of an AI/ML model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and receiving, from the terminal device, the information based on the configuration.

In a seventh aspect, there is provided a communication method. The method comprises: receiving, at a terminal device, from a network device, a first indication to select at least one of a first component of an AI/ML model or a second component of the AI/ML model, wherein the first component is used by the terminal device, and the second component is used by the network device; and in response to the first indication, determining at least one of the following: one or more results associated with a measurement, a terminal component to be used as the first component, or a network component to be used as the second component.

In an eighth aspect, there is provided a communication method. The method comprises: transmitting, at a network device, to a terminal device, a first indication to select at least one of a first component of an AI/ML model or a second component of the AI/ML model, wherein the first component is used by the terminal device, and the second component is used by the network device.

In a ninth aspect, there is provided a computer readable medium having instructions stored thereon, the instructions, when executed on at least one processor, causing the at least one processor to carry out the method according to the fifth, sixth, seventh, or eighth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates a framework of an AI/ML model;

FIG. 1B illustrates an example communication environment in which example embodiments of the present disclosure can be implemented;

FIG. 2 illustrates a signaling flow of reporting information concerning model management in accordance with some embodiments of the present disclosure;

FIG. 3A, FIG. 3B and FIG. 3C illustrate example hierarchical structures of the configuration in accordance with some embodiments of the present disclosure;

FIG. 4A illustrates a signaling flow of model interference in accordance with some embodiments of the present disclosure;

FIG. 4B illustrates a signaling flow of model monitoring at the terminal device in accordance with some embodiments of the present disclosure;

FIG. 4C illustrates a signaling flow of model monitoring at the network device in accordance with some other embodiments of the present disclosure;

FIG. 4D illustrates a signaling flow of model training in accordance with some embodiments of the present disclosure;

FIG. 4E illustrates a signaling flow of model training in accordance with some other embodiments of the present disclosure;

FIG. 4F illustrates a signaling flow of model training in accordance with some further embodiments of the present disclosure;

FIG. 5A and FIG. 5B illustrate signaling flows in the case of training type 1 in accordance with some embodiments of the present disclosure;

FIG. 6 illustrates a signaling flow in the case of training type 1 in accordance with some other embodiments of the present disclosure;

FIG. 7 illustrates a signaling flow in the case of training type 2 in accordance with some embodiments of the present disclosure;

FIG. 8 illustrates a signaling flow in the case of training type 3 starting with network side training in accordance with some embodiments of the present disclosure;

FIG. 9A and FIG. 9B illustrate signaling flows in the case of training type 3 starting with terminal side training in accordance with some embodiments of the present disclosure;

FIG. 10 illustrates a signaling flow of model alignment in accordance with some embodiments of the present disclosure;

FIG. 11A, FIG. 11B and FIG. 11C illustrate example signaling flows of model alignment in accordance with some embodiments of the present disclosure;

FIG. 12 illustrates a signaling flow in the case with a fixed network component in accordance with some embodiments of the present disclosure;

FIG. 13 illustrates a signaling flow in the case with a fixed terminal component in accordance with some embodiments of the present disclosure;

FIG. 14 illustrates a signaling flow in the case with multiple network components and multiple terminal components in accordance with some embodiments of the present disclosure;

FIG. 15 illustrates a flowchart of a method implemented at a terminal device according to some example embodiments of the present disclosure;

FIG. 16 illustrates a flowchart of a method implemented at a network device according to some example embodiments of the present disclosure;

FIG. 17 illustrates a flowchart of a method implemented at a terminal device according to some example embodiments of the present disclosure;

FIG. 18 illustrates a flowchart of a method implemented at a network device according to some example embodiments of the present disclosure;

FIG. 19 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “AI/ML model” may refer to a data driven algorithm that applies AI/ML techniques to generate a set of outputs based on a set of inputs. In the context of the present disclosure, the term “AI/ML model” may be interchangeably with the terms “model”, “AI model” and “ML model”.

As used herein, the term “data collection” may refer to a process of collecting data by the network nodes, management entity, or UE for the purpose of AI/ML model training, data analytics and inference. The term “AI/ML model training” may refer to a process to train an AI/ML Model [by learning the input/output relationship] in a data driven manner and obtain the trained AI/ML Model for inference. The term “AI/ML model inference” may refer to a process of using a trained AI/ML model to produce a set of outputs based on a set of inputs.

The term “AI/ML model validation” used herein may refer to a subprocess of training, to evaluate the quality of an AI/ML model using a dataset different from one used for model training, that helps selecting model parameters that generalize beyond the dataset used for model training. The term “AI/ML model testing” used herein may refer to a subprocess of training, to evaluate the performance of a final AI/ML model using a dataset different from one used for model training and validation. Differently from AI/ML model validation, testing does not assume subsequent tuning of the model.

The term “UE-side (AI/ML) model” used herein may refer to an AI/ML Model of which inference is performed entirely at the UE. The term “network-side (AI/ML) model” used herein may refer to an AI/ML Model of which inference is performed entirely at the network. The term “one-sided (AI/ML) model” used herein may refer to a UE-side (AI/ML) model or a network-side (AI/ML) model. The term “two-sided (AI/ML) model” used herein may refer to a paired AI/ML Model(s) over which joint inference is performed, where joint inference comprises AI/ML Inference whose inference is performed jointly across the UE and the network, i. e, the first part of inference is firstly performed by UE and then the remaining part is performed by gNB, or vice versa.

The term “AI/ML model transfer” used herein may refer to a delivery of an AI/ML model over the air interface, either parameters of a model structure known at the receiving end or a new model with parameters. Delivery may contain a full model or a partial model. The term “model download” used herein may refer to model transfer from the network to UE. The term “model upload” used herein may refer to model transfer from UE to the network. The term “federated learning/federated training” used herein may refer to a machine learning technique that trains an AI/ML model across multiple decentralized edge nodes (e.g., UEs, gNBs) each performing local model training using local data samples. The technique requires multiple interactions of the model, but no exchange of local data samples.

The term “offline field data” used herein may refer to the data collected from field and used for offline training of the AI/ML model. The term “online field data” used herein may refer to the data collected from field and used for online training of the AI/ML model. The term “model monitoring” used herein may refer to a procedure that monitors the inference performance of the AI/ML model.

The term “supervised learning” used herein may refer to a process of training a model from input and its corresponding labels. The term “unsupervised learning” used herein may refer to a process of training a model without labelled data. The term “semi-supervised learning” used herein may refer to a process of training a model with a mix of labelled data and unlabelled data. The term “reinforcement Learning (RL)” used herein may refer to a process of training an AI/ML model from input (also known as state) and a feedback signal (also known as reward) resulting from the model's output (also known as action) in an environment the model is interacting with.

The term “model activation” used herein may refer to enabling an AI/ML model for a specific function. The term “model deactivation” used herein may refer to disabling an AI/ML model for a specific function. The term “model switching” used herein may refer to deactivating a currently active AI/ML model and activating a different AI/ML model for a specific function.

The term “model failure” used herein may refer to a negative outcome of model monitoring. The term “model failure instance” used herein may refer to one wrong inference. The term “model failure instance indication” used herein may refer to an indication of model failure instance from lower layer to higher layer.

As used herein, the term “online training” may refer to an AI/ML training process where the model being used for inference is (typically continuously) updated trained in (near) real-time with the arrival of new training samples in (near) real-time. It is to be noted that the notion of (near) real-time vs. non real-time is context-dependent and is relative to the inference time-scale. It is also to be noted that the above definition of “online training” only serves as a guidance and there may be cases that may not exactly conform to this definition but could still be categorized as online training by commonly accepted conventions. Further, it is to be notes that fine-tuning/re-training may be done via online or offline training.

As used herein, the term “offline training” may refer to an AI/ML training process where the model is trained based on collected dataset, and where the trained model is later used or delivered for inference. It is to be noted that this definition for “offline training” only serves as a guidance and there may be cases that may not exactly conform to this definition but could still be categorized as offline training by commonly accepted conventions.

As used herein, the term “AI/ML model delivery” may refer to a generic term referring to delivery of an AI/ML model from one entity to another entity in any manner. It is to be noted that an entity could mean a network node/function (e.g., gNB, LMF, etc.), UE, proprietary server, etc. The term “model registration” used herein may refer to a process of informing the existence of an AI/ML model to the network or to the UE with an identification, along with model description information of the AI/ML model for the network to enable life cycle management (LCM).

The term “proprietary-format models” as used herein may refer to ML models of vendor-/device-specific proprietary format, from 3rd generation partnership project (3GPP) perspective. It is to be noted that an example is a device-specific binary executable format. The term “open-format models” as used herein may refer to ML models of specified format that are mutually recognizable across vendors and allow interoperability, from 3GPP perspective.

The term “model identification” as used herein may refer to a process/method of identifying an AI/ML model for the common understanding between the NW and the UE. It is to be noted that the process/method of model identification may or may not be applicable. It is to be noted that information regarding the AI/ML model may be shared during model identification.

The term “functionality identification” as used herein may refer to a process/method of identifying an AI/ML functionality for the common understanding between the NW and the UE. It is to be noted that information regarding the AI/ML functionality may be shared during functionality identification.

The term “model update” as used herein may refer to a process of updating the model parameters and/or model structure of a model. The term “model parameter update” as used herein may refer to a process of updating the model parameters of a model.

### Example Communication Environment

Principles and implementations of the present disclosure will be described in detail below with reference to the figures.

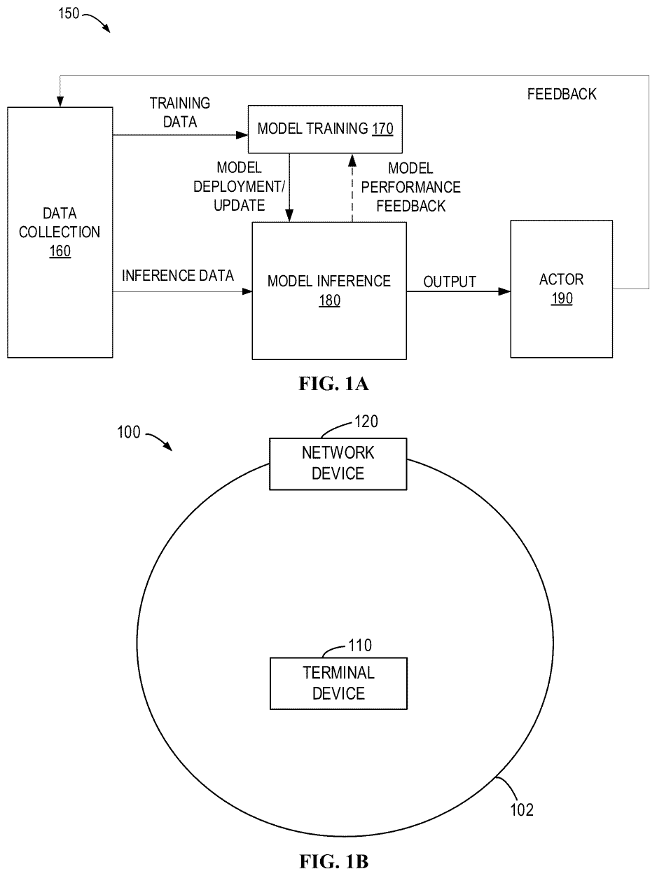

As mentioned above, the AI/ML technology has been proposed. FIG. 1A shows a schematic diagram of an AL/ML framework 150. As shown in FIG. 1A, the AI/ML framework 150 may include a data collection module 160, a model training module 170, a model inference model 180, and an actor 190. The data collection module 160 may implement a function that provides input data to model training and model inference modules. AI/ML algorithm specific data preparation (e.g., data pre-processing and cleaning, formatting, and transformation) is not carried out in the data collection module 160. Examples of input data may include measurements from UE or different network entities, feedback from the actor 190, output from an AI/ML model. The training data may refer to data needed as input for the model training module 170. The inference data may refer to data input for the model inference module 180.

The model training module 170 may implement a function that performs the AI/ML model training, validation, and testing which may generate model performance metrics as part of the model testing procedure. The model training 170 is also responsible for data preparation (e.g., data pre-processing and cleaning, formatting, and transformation) based on training data delivered by a data collection function, if required. Model deployment/update may be used to initially deploy a trained, validated, and tested AI/ML model to the model inference module 180 or to deliver an updated model to the model inference module 180.

The model inference module 180 may implement a function that provides AI/ML model inference output (e.g., predictions or decisions). The model inference model 180 may provide a model performance feedback to the model training module 170 when applicable. The model inference module 180 is also responsible for data preparation (e.g., data pre-processing and cleaning, formatting, and transformation) based on inference data delivered by the data collection module 160, if required. An output of the model inference module 180 may refer to an inference output of the AI/ML model produced by a Model Inference function. The model performance feedback may be used for monitoring the performance of the AI/ML model, when available.

The actor 190 may implement a function that receives the output from the model inference module 180 and triggers or performs corresponding actions. The actor 190 may trigger actions directed to other entities or to itself.

FIG. 1B illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1B, the terminal device 110 may be a UE and the network device 120 may be a base station serving the UE. The serving area of the network device 120 may be called a cell 102.

It is to be understood that the number of devices and their connections shown in FIG. 1B are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the communication environment 100, an AI/ML model can be applied to different scenarios to achieve better performances. In some embodiments, the terminal device 110 can perform channel state information (CSI) feedback using the AI/ML model. For example, spatial-frequency domain CSI compression may be performed using two-sided AI model. In this situation, the original CSI can be compressed by an AI encoder located in the terminal device 110 and recovered by an AI decoder located in the network device 120. For another example, time domain CSI prediction may be performed using UE side model. In embodiments of the present disclosure, CSI may include, but not limited to, Channel Quality Indicator (CQI), precoding matrix indicator (PMI), CSI-RS resource indicator (CRI), Synchronization Signal (SS)/Physical Broadcast Channel (PBCH) Block Resource indicator (SSBRI), layer indicator (LI), rank indicator (RI), L1-Reference Signal Received Power (RSRP), L1-Signal to Interference plus Noise Ratio (SINR) or Capability[Set]Index.

Alternatively, or in addition, in some embodiments, beam management may be performed using the AI/ML model. For example, a spatial-domain DL beam may be predicted for Set A of beams based on measurement results of Set B of beams. For another example, a temporal DL beam may be predicted for Set A of beams based on the historic measurement results of Set B of beams.

Alternatively, or in addition, in some embodiments, positioning accuracy may be enhanced using the AI/ML model for different scenarios, for example, a direct AI/ML positioning, AI/ML assisted positioning, etc. It is to be understood that the above usages of the AI/ML model are given as examples without any limitation.

In some embodiments, the AI/ML model may be a two-sided model, which comprises a first part for using by the terminal device 110 and a second part for using the network device 120. The first part may be used to generate an intermediate result from an initial result and the second part may be used to generate a reconstructed result from the intermediate result. In the following, the first part may be referred to as a terminal part, UE side part, or UE part, which can be used interchangeably. The second part may be referred to as a network part, NW side part, or NW part, which can be used interchangeably. Different first part or second part may be different in any suitable aspect, including but not limited to, the structure of AI/ML model (Convolutional Neural Network, CNN, transformer, one-layer model, etc.), the number of layers, the input/output size, the number of parameters/hyper-parameters, quantization method (quantizer) the application condition, etc.

In an example, two-sided model may be used for CSI feedback to compress and reconstruct CSI, where the first part is used for CSI compression and the second part is used for CSI reconstruction. In the example of CSI report, the first part of the AI/ML model is also referred to as encoder, CSI encoder, CSI compression part and CSI generation part, which can be used interchangeably. Similar, the second part of the AI/ML model is also referred to as decoder, CSI decoder, CSI reconstruction part, CSI recovery part, which can be used interchangeably. In this example, the input to the first part may be original CSI in spatial-frequency domain, CSI in legacy format, high-resolution CSI, etc., and output from the first part may be compressed bits, compressed CSI, generated CSI, CSI feedback, etc. Input to the second part may include at least reported CSI from the terminal device 120, and output from the second part may be recovered CSI, reconstructed CSI. In embodiments of the present disclosure, CSI in legacy format may include, but not limited to, type I codebook, type II codebook, port selection codebook, and the enhancements based on those legacy formats.

Different types of training collaborations may be employed for the two-sided model. In some embodiments, training type 1 may be employed. In the training type 1, joint training of the two-sided model is implemented at a single side or entity, e.g., at the side of the terminal device 110 or at the side of the network device 120.

In some embodiments, training type 2 may be employed. In the training type 2, joint training of the two-sided model is implemented at the side of the terminal device 110 and the side of the network device 120, respectively. As an example procedure, for each forward propagation (FP) and backward propagation (BP) loop, the terminal device 120 generates the FP results (for example, CSI feedback) based on the data sample(s), and sends the FP results to the network device 110. The network device 110 reconstructs the result based on FP results, trains the network part, and generates the BP information (e.g., gradients), which are then sent to the terminal device 110. The terminal device 110 trains the terminal part based on the BP information from the network device 110. It is to be noted that the dataset between the terminal device 110 side and the network device 120 side is aligned. Other Type 2 training procedures are not precluded.

In some embodiments, training type 3 may be employed. In the training type 3, separate training is implemented at the side of the terminal device 110 and the side of the network device 120, where the first part and the second part are trained by the terminal device 110 and the network device 120, respectively. In an example procedure of the sequential training starting with network side training (also referred to as network first training), the network device 120 trains the terminal part (which is not used for inference) and the network part jointly. After the network side training is finished, the network device 120 shares the terminal device 110 with a set of information (e.g., dataset) that is used by the terminal device 110 to be able to train the terminal part. The terminal device 110 trains the terminal part based on the received set of information. Other type 3 network-first training procedures are not precluded.

In an example procedure of the sequential training starting with terminal side training (also referred to as terminal first training), the terminal device 110 trains the terminal part and the network part (which is not used for inference) jointly. After terminal side training is finished, the terminal device 110 shares the network device 120 with a set of information (e.g., dataset) that is used by the network device 120 to be able to train the network part. The network device 120 trains the network part based on the received set of information. Other type 3 terminal-first training procedures are not precluded.

It is to be noted that joint training means the first part and second part should be trained in the same loop for forward propagation and backward propagation. Joint training could be done at single node, or across multiple nodes (e.g., through gradient exchange between nodes). It is to be noted that separate training includes sequential training starting with terminal side training, or sequential training starting with network side training (or parallel training) at the terminal device 110 and the network device 120. It is to be understood that the above three types of training collaboration are given as examples and other collaboration types are not excluded.

LCM for the AI/ML model may include, but not limited to, the following stages/phases: data collection, model training, model registration, model deployment, model configuration, model inference, model selection, model activation, model deactivation, model switching, and fallback operation, model monitoring, model update, model transfer, UE capability reporting, etc. LCM is one of core parts for AI/ML related studies.

However, how to report information related to the AI/ML model needs to be studied. As an example, following issues need to be studied: metrics for AI/ML model monitoring in LCM, performance monitoring considering the key performance indicators such as accuracy and relevance, overhead, complexity, latency, power consumptions. As another example, for terminal part or terminal side models, two mechanisms for LCM need to be studied, that is, a functionality-based LCM procedure and model-ID based LCM procedure. For the functionality-based LCM procedure, an indication of activation/deactivation/switching/fallback based on individual AI/ML functionality is to be studied. For model-ID-based LCM procedure, an indication of model selection/activation/deactivation/switching/fallback based on individual model IDs need to be studied.

In order to solve at least part of the above problems, embodiments of the present disclosure provide a solution for managing an AI/ML model. The network device determines a configuration for a terminal device to at least report information concerning a management of the AI/ML model. The configuration has a hierarchical structure. In other words, the configuration comprises parameters of a plurality of levels, and a parameter of a higher level is associated with one or more parameters of a lower level. To specify how to report the information concerning the management, the parameters of the plurality of levels comprises two or more of the following: one or more parameters of a first level indicating the AI/ML model, one or more parameters of a second level indicating a stage of the management, or one or more parameters of a third level indicating a dataset. The network device transmits the configuration to the terminal device. The terminal device reports the information to the network device based on the configuration. In this way, management of the AI/ML model is supported, so as to ensure satisfying communication performances.

### Example Signaling Flow for Model Management

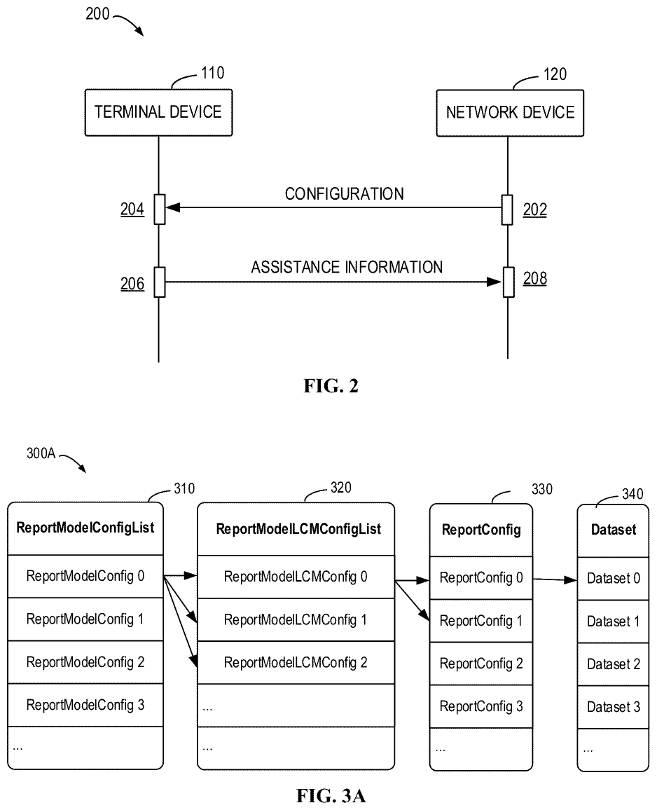

Reference is made to FIG. 2, which illustrates a signaling flow 200 of reporting information concerning model management in accordance with some embodiments of the present disclosure. For the purposes of discussion, the signaling flow 200 will be discussed with reference to FIG. 1B, for example, by using the terminal device 110 and the network device 120.

The network device 120 transmits 202, to the terminal device 110, a configuration for at least reporting information concerning a management of the AI/ML model, which may be also referred to as “model management information” or “assistance information”. In other words, the configuration at least specified the reporting of the assistance information from the terminal device 110 to the network device 120.

The configuration has a hierarchical structure and thus is also referred to as a hierarchical configuration. The configuration comprises parameters of a plurality of levels, and a parameter of a higher level is associated with one or more parameters of a lower level. The parameters of the plurality of levels comprise two or more of the following: one or more parameters of a first level indicating the AI/ML model, one or more parameters of a second level indicating a stage of the management, or one or more parameters of a third level indicating a dataset.

Although the terms “first”, “second” and “third” are used herein, these terms do not suggest any limitation to the actual positions of the parameters in the hierarchical structure. Parameters of the first, second and third levels and any other levels may be arranged in any suitable order in the hierarchical structure. In an example, the one or more parameters of the first level are higher than the one or more parameters of the second level, which are in turn higher than the one or more parameters of the third level. Alternatively, in another example, the one or more parameters of the second level are higher than the one or more parameters of the first level, which are in turn higher than the one or more parameters of the third level. It is to be understood that other orders are possible.

In some embodiments, the configuration may be further used for reporting a result for a measurement. For example, if the model is used for CSI feedback, the configuration may be further used for CSI report. In such embodiments, the parameters of the plurality of levels may further comprise at least one of the following: one or more parameters of a fourth level indicating a resource for the terminal device 110 to perform the measurement, or one or more parameters of a fifth level of parameters indicating a scheme for reporting the information and the result, for example, what, when and how to report the assistance information and the result.

To better understand the hierarchical configuration, examples are described with respect to the scenario of CSI report where the AI/ML model is used to process CSI. One or more parameters of a certain level may correspond to an information element (IE). In the CSI report scenario, the hierarchical configuration may comprise the parameters “CSI-ReportForAI”, “ReportModelConfig”, “ReportModelLCMConfig”, “ReportConfig” and “Dataset”. The parameter “CSI-ReportForAI” defines that the report is associated with an AI/ML model.

The parameter “ReportModelConfig” defines which model the terminal device 120 should report for. The possible value may include, but not limited to, the following AI/ML model related information: model identification (ID), model type, collaboration level, network part ID, terminal part ID, the functionality of the model, model description, the structure of the model, the parameters of the model, etc. If multiple models have been developed, or if multiple terminal parts have been developed for one network part for one model, or if multiple network parts have been developed for one terminal part for one model, a combination of model information, terminal part information, and network part information can jointly identify a model.

The parameter “ReportModelLCMConfig” defines which LCM stage the terminal device 120 should report for. The possible value may include, but not limited to, the following LCM stages or phases: data collection for model training/inference/monitoring/update, model training, model inference, model monitoring, model update, model selection, etc. If “data collection” is configured as the value of “ReportModelLCMConfig”, dataset information may additionally be expected to be configured (for example, within the IE “ReportModelLCMConfig” or by other parameters like Dataset), e.g., dataset ID, input distribution, output distribution, network side dataset ID, terminal side dataset ID, etc.

The parameter “Dataset” defines based on which dataset the terminal device 120 should report. The parameter “Dataset” is useful when dataset is not real-time, e.g., delivered from other parities, collected during a time duration, for training, for monitoring (based on distribution of input/output of AI/ML model), etc.

The parameter “ReportConfig” defines the scheme for reporting the CSI and the assistance information. That is, this IE defines when, what, and how the terminal device 120 should report.

The above parameters may be arranged in any suitable order. In some embodiments, an order from high to low may be from the parameter “CSI-ReportForAI”, the parameter “ReportModelConfig”, the parameter “ReportModelLCMConfig”, the parameter “ReportConfig” to the parameter “Dataset”. Accordingly, the parameter “CSI-ReportForAI” is linked to one or multiple parameters “ReportModelConfig” via e.g., ReportModelConfigList. The parameter “ReportModelConfig” is linked to one or multiple parameters “ReportModelLCMConfig” via e.g., ReportModelLCMConfigList. The parameter “ReportModeILCMConfig” is linked to one or multiple parameters “ReportConfig”. The parameter “ReportConfig” is linked to one or multiple parameters “Dataset”.

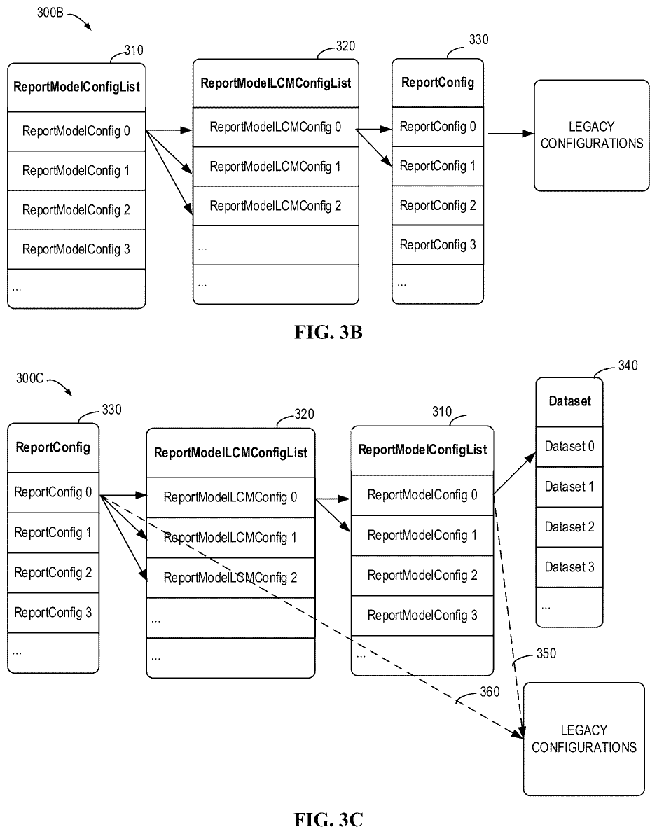

FIG. 3A shows an example hierarchical configuration 300A according to some embodiments of the present disclosure. The parameter “ReportModelConfig 0” in ReportModelConfigList 310 is linked to the parameters “ReportModelLCMConfig 0”, “ReportModelLCMConfig 1” and “ReportModelLCMConfig 2” in ReportModelLCMConfigList 320. The parameter “ReportModeILCMConfig 0” is in turn linked to the parameters “ReportConfig 0” and “ReportConfig 1” in ReportConfig 330. The parameter “ReportConfig 0” is in turn linked to the parameter “dataset 0” in Dataset 340.

Alternatively, in some embodiments, an order from high to low may be from the parameter “CSI-ReportForAI”, the parameter “ReportModelConfig”, the parameter “ReportModelLCMConfig”, the parameter “ReportConfig” and then legacy configuration for CSI report. FIG. 3B shows an example hierarchical configuration 300B for such embodiments. As an example, the legacy configuration may have a following order: from the parameter “ReportConfig”, the parameter “ResourceConfig”, the parameter “resource set” to the parameter “resource”. The parameter “ReportConfig” is linked to one or multiple parameters “ResouceConfig”. The parameter “ReportConfig” defines when/what/how UE should report for CSI. “ResourceConfig” is linked to one or multiple resource sets via ResourceSetList. ResourceSet contains information of one or multiple Resources via ResourceList. Resource is the minimum unit for physical layer configuration.

Alternatively, in some embodiments, the parameter ReportConfig may correspond to the parent IE, and the parameter “CSI-ReportForAI” may correspond to the next level. For example, a hierarchical structure for CSI report may be what/when/how to report, report for AI, report for which Model, report for which LCM stage, report for which dataset, resource/method to measure. FIG. 3C shows a such example hierarchical configuration 300C. In such embodiments, the parameter “ReportConfig” is linked to one or multiple parameters “ReportModelConfig”. The parameter “ReportModelConfig” is linked to one or multiple parameters “ReportModelLCMConfig”. The parameter “ReportModelLCMConfig” is linked to one or multiple parameters “dataset”.

In addition, the parameter “ReportConfig” may be linked to one or multiple “ResouceConfig” in the legacy configuration, as shown by the arrow 360. Alternatively, the parameter “ReportModelLCMConfig” may be linked to one or multiple parameters “ResourceConfig” in the legacy configuration, as shown by the arrow 350.

It is to be understood that the above example hierarchical structures 300A, 300B and 300C are illustrated as examples without any limitation. The above-mentioned parameters may be arranged in any suitable hierarchical structure. Moreover, one or more of these parameters may not be configured.

Reference is made back to FIG. 2. The terminal device 110 receives 204 the configuration from the network device 120. Then, the terminal device 110 transmits 206 at least the assistance information to the network device 120 based on the received configuration. Depending on the stage of the LCM, the assistance information may comprise different contents. In some embodiments, the terminal device 110 may further transmit a result processed using at least a part of the AI/ML model to network device 120. Accordingly, the network device 120 receives 208 from the terminal device 110 the assistance information and optionally the processed result.

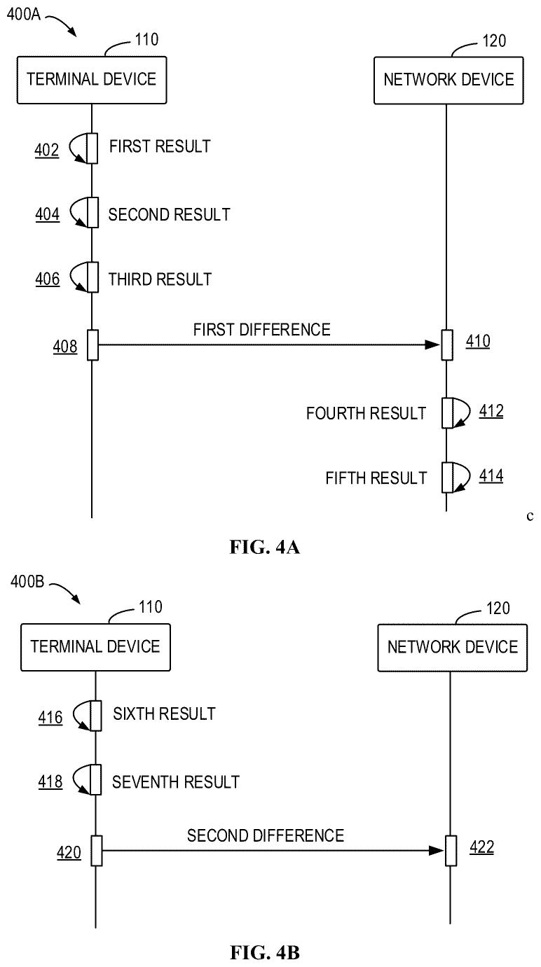

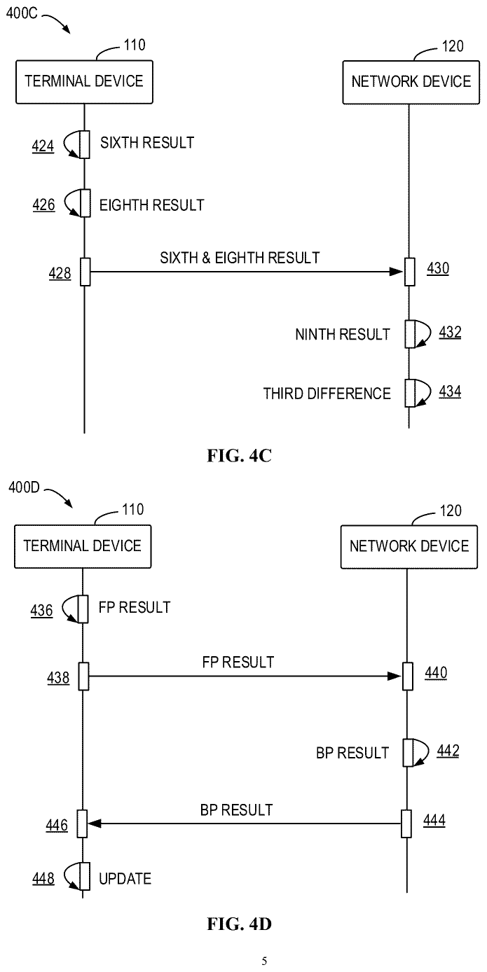

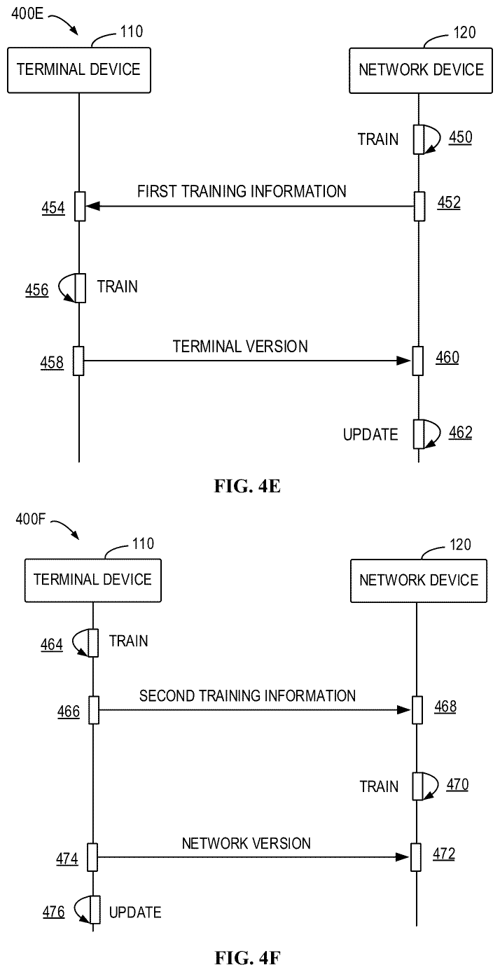

Reference is now made to FIGS. 4A to 4F to illustrate example interactions between the terminal device 110 and the network device 120 in different stages of LCM.

In some embodiments, as mentioned above, the AI/ML model may be a two-sided model, comprising a first part and a second part. In some embodiments, the terminal device 110 may have a terminal version of the second part, which is not used for interference. For example, in the case of training type 1, the terminal device 110 may have the terminal version, which is the same as a network version of the second part. For another example, in the case of training type 3 starting from the terminal device 110 side, the terminal version of the second part may not be exactly the same as the network version of the second part.

In such embodiments, the terminal version may be used in the model interference. Accordingly, a parameter of the second level may indicate the model interference. Additionally, the parameter of the first level may include the model ID and additionally the model type, first part ID and second part ID. FIG. 4A illustrates a signaling flow 400A of model interference in accordance with some embodiments of the present disclosure.

The terminal device 110 obtains 402 a first result for a measurement by measuring on a first resource indicated by the configuration. For example, the terminal device 110 may perform measurement on the first resource and obtain the first result as an original result. The terminal device 110 generates 404 a second result based on the first result by using the first part. For example, the first part takes the first result as input and outputs the second result. The terminal device 110 then generates 406 a third result based on the second result by using a terminal version of the second part. For example, the second result is input to the terminal version, which outputs the third result. Then, the terminal device 110 compares the first and third results to determine a first difference between the first and third results. The terminal device 110 transmits 408 the second result and the first difference to the network device 120. In these embodiments, the configuration (for example, the parameter of the fifth level) may indicate the terminal device 110 to report the first difference to the network device 120.

The network device 120 receives 410 the second result and the first difference. Then, the network device 120 generates 412 a fourth result based on the second result by using the network version of the second part. For example, the second result is input to the network version of the second part, which outputs the fourth result. The network device 120 obtains 414 a fifth result based on the fourth result and the first difference. For example, the first difference may be used to correct the fourth result to obtain the fifth result.

In such embodiments, the exchange of the first difference can facilitate to achieve a more accurate result at the network side.

Alternatively, or in addition, in some embodiments, the terminal version of the second part may be used for the model monitoring at the terminal device 120. Accordingly, a parameter of the second level may indicate the model monitoring, and may additionally indicate a model monitoring approach. Additionally, the parameter of the first level may include the model ID and additionally the model type, first part ID and second part ID. FIG. 4B illustrates a signaling flow 400B of model monitoring at the terminal device 120 in accordance with some embodiments of the present disclosure.

As shown, the terminal device 110 obtains 416 a sixth result for a measurement by measuring a second resource indicated by the configuration. For example, the terminal device 110 may perform measurement on the second resource and obtain the sixth result as an original result. The terminal device 110 then generates a seventh result based on the sixth result by using the first part and a terminal version of the second part. For example, the terminal device 110 may input the sixth result into the first part to obtain an intermediate result, and then input the intermediate result into the terminal version of the second part to obtain the seventh result. Then, the terminal device 110 compares the sixth and seventh results to determine a second difference therebetween. The terminal device 110 transmits 420 at least the second difference to the network device 120. The terminal device 110 may additionally transmit other result to the network device 120. In these embodiments, the configuration (for example, the parameter of the fifth level) may indicate the terminal device 110 to report the second difference to the network device 120.

The network device 120 receives 422 the second difference from the terminal device 110. In this way, the network device 110 can be aware of the performance of the AI/ML model.

Alternatively, in some embodiments, the model monitoring may be performed at the network side. Accordingly, a parameter of the second level may indicate the model monitoring, and may additionally indicate a model monitoring approach. Additionally, the parameter of the first level may include the model ID and additionally the model type, first part ID and second part ID. FIG. 4C illustrates a signaling flow 400C of model monitoring at the network device in accordance with some other embodiments of the present disclosure.

As shown, the terminal device 110 obtains 424 a sixth result for a measurement by measuring a second resource indicated by the configuration. For example, the terminal device 110 may perform measurement on the second resource and obtain the sixth result as an original result. The terminal device 110 then generates 426 an eighth result based on the sixth result by using the first part. For example, the first part may be fed with the sixth result as input and output the eighth result. Then, the terminal device 110 transmits 428 the sixth and eighth results to the network device 120. Accordingly, in these embodiments, the configuration (for example, the parameter of the fifth level) may indicate the terminal device 110 to report the original result and the result processed by the first part to the network device 120.

The network device 120 receives 430 the sixth and eighth results from the terminal device 110. The network device 120 then generates 432 a ninth result based on the eighth result by using a network version of the second part. For example, the network version of the second part may take the eighth result as input and output the ninth result. Next, the network device 120 compares 434 the sixth and ninth results to determine a third difference between the sixth and ninth results. In this way, the performance of the AI/ML model can be monitored.

Alternatively, or in addition, in some embodiments, the two-sided model may be trained using a procedure of the training type 2. Accordingly, the parameter of the second level may indicate model training or model update. Alternatively, the parameter of the second level may indicate data collection for model training or model update. Additionally, the parameter of the first level may comprise a model ID, a first part ID and a second part ID. The parameter of the third level may comprise a dataset ID identifying the dataset used for training. FIG. 4D illustrates a signaling flow 400D of model training in accordance with some embodiments of the present disclosure.

As shown, the terminal device 110 generates 436 a FP result based on a training sample by using the first part. For example, a batch of samples may be fed into the first part and the first part generates a batch of FP results. In the case of CSI feedback, the FP results may be compressed CSI. Then, the terminal device 110 transmits 438 the FP result to the network device 120.

Accordingly, the network device 120 receives 440 the FP result from the terminal device 110. The network device 120 generates 442 a BP result based on the FP result and the training sample by using the second part. Specifically, the FP result may be input into the second part to generate a reconstructed result. A difference between the reconstructed result and the training sample may be used to determine the BP result, for example, a gradient. Then, the network device 120 transmits 444 the BP result to the terminal device 110.

The terminal device 110 receives 446 the BP result from the network device 120 and updates 448 the first part based on the BP result. In other words, the BP result is used to train the first part. Then, a new FP result or a new batch of FP results may be generated and transmitted to the network device 120. This mean that the signaling flow 400D may be performed iteratively until model convergence or for predetermined turns.

Alternatively, in some embodiments, the two-sided model may be trained using a procedure of the training type 3 starting with the network device 120 side. In such embodiments, the network device 120 may have a network version of the first part, which is not used for inference. The terminal device 110 may have a terminal version of the first part, which is used for inference and might be different from the network version. The difference between the network and terminal versions of the first part may cause a misalignment between the terminal version and the second part for model inference, resulting in a performance degrade of the AI/ML model. Therefore, the difference between the network and terminal versions needs to be decreased.

FIG. 4E illustrates a signaling flow 400E of model training in accordance with some other embodiments of the present disclosure. As shown, the network device 120 trains 450 the second part and a network version of the first part. The network device 120 then transmits 452, to the terminal device 110, first training information concerning the first part. The first training information may include information about the dataset used to train the second part and the network version. In addition, the first training information may include a reference model, a reference first part, a reference second part, quantization/dequantization approaches applied at the network device 120, etc.

The terminal device 110 receives 454 the first training information from the network device 120 and trains 456 a terminal version of the first part based on the first training information. For example, the terminal device 110 may train the terminal version of the first part based on the dataset used by the network device 120. Then, the terminal device 110 transmits 458 information concerning the trained terminal version of the first part to the network device 120. Such information may include parameter values of the trained terminal version or any suitable information available for accessing the trained terminal version.

The network device 120 receives 460 the information concerning the trained terminal version from the terminal device 110. Next, the network device 120 updates 462, based on the terminal version, at least one of the second part and the network version of the first part. For example, the second part and the network version of the first part may be further tuned based on the terminal version until model convergence.

In such embodiments, the AI/ML model is further tuned based on the terminal version of the first part. In this way, the first and second parts used for model inference can be matched to each other as much as possible. The performance degrade of the AI/ML model in case of the training type 3 can be at least alleviated.

Alternatively, in some embodiments, the two-sided model may be trained using a procedure of the training type 3 starting with the terminal device 110 side. In such embodiments, the terminal device 110 may have a terminal version of the second part, which is not used for inference. The network device 110 may have a network version of the second part, which is used for inference and might be different from the terminal version. The difference between the network and terminal versions of the second part may cause a misalignment between the network version and the first part for model inference, resulting in a performance degrade of the AI/ML model. Therefore, the difference between the network and terminal versions of the second part need to be decreased.

FIG. 4F illustrates a signaling flow 400F of model training in accordance with some further embodiments of the present disclosure. As shown, the terminal device 110 trains 464 the first part and a terminal version of the second part and then transmits 466, to the network device 120, second training information concerning the second part. The second training information may include information about the dataset used to train the first part and the terminal version. In addition, the second training information may include a reference model, a reference first part, a reference second part, quantization/dequantization approaches applied at the terminal device 110, etc.

The network device 120 receives 468 the second training information from the terminal device 110 and trains 470 a network version of the second part based on the second training information. For example, the network device 120 may train the network version of the second part based on the dataset used by the terminal device 110. Then, the network device 120 transmits 472 information concerning the trained network version of the second part to the terminal device 110. Such information may include parameter values of the trained network version or any suitable information available for accessing the trained network version.

The terminal device 110 receives 474 the information concerning the trained network version from the network device 120. The terminal device 110 then updates 476, based on the network version, at least one of the first part and the terminal version of the second part. For example, the first part and the terminal version of the second part may be further tuned based on the network version until model convergence.

In such embodiments, the AI/ML model is further tuned based on the network version of the second part. In this way, the first and second parts used for model inference can be matched to each other as much as possible. The performance degrade of the AI/ML model in case of the training type 3 can be at least alleviated.

It is to be understood that the signaling flows 400E and 400F may be used for the purpose of model alignment, as will be described below.

Some example embodiments have been described above with reference to FIGS. 2 to 4F. A hierarchical configuration is introduced to report the assistance information and measurement results and the association between the measurement report and the assistance information is also introduced. In this way, LCM of the AI/ML model can be supported.

### Example Use Cases for Model Management

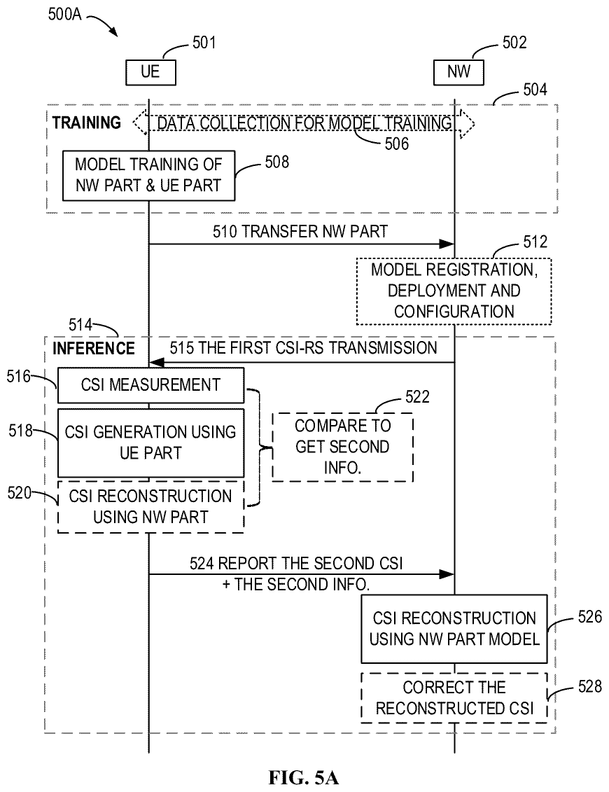

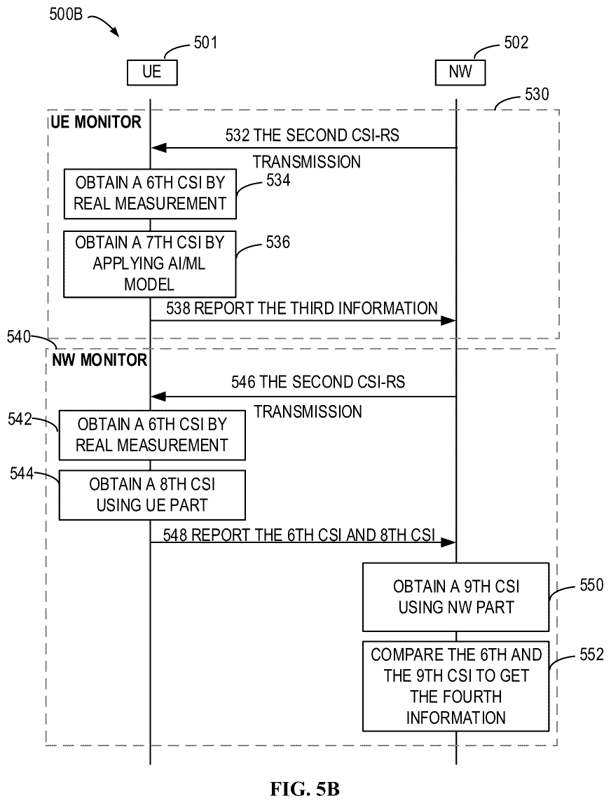

To better understand the solution for model management, in particular the two-sided model, according to the present disclosure, reference is made to FIGS. 5A to 9B to illustrate some example use cases. In these example use cases, the AI/ML model is used for CSI feedback, the UE 501 is an example of the terminal device 110, and the NW 502 is an example of the network device 120. Accordingly, the UE part of the model is an example of the first part and the NW part of the model is an example of the second part.

Reference is first made to FIG. 5A and FIG. 5B, which show the case of training type 1 at the UE side. In general, the signaling flow 500A includes a flow 504 for model training and a flow 514 for model inference. Data collection for model training may be performed at 506. At 508, model training of the UE part and the NW part is performed at the UE 501. In other words, the UE 501 trains the CSI generation part (which is the UE part) and the CSI reconstruction part (which is the NW part) jointly. Alternatively, the UE 501 may obtain the AI/ML model from other entity. After training is finished, the UE 501 shares part of the trained model, e.g., the CSI reconstruction part, to the NW 502. Accordingly, at 510, the NW part is transferred to the NW 502.

At 512, model registration, deployment and configuration of the NW part are performed. For example, the transferred model(s) or part(s) may be registered at the NW 502 side for the UE 501. The NW 502 may deploy the CSI reconstruction part and may assign ID(s) to the AI/ML model(s). In addition, the NW 502 may notify the UE 501 of the status of the registration, deployment, etc.

The flow 514 for model inference may be considered as an example implementation of the signaling flow 400A. The hierarchical configuration may include parameters “CSI-ReportForAI”, “ReportModelConfig”, “ReportModelLCMConfig”, “ReportConfig”, “ResourceConfig”, “resource set”, “resource”. The parameter “ReportModelConfig” may indicate or include a model ID and may additionally include or indicate a model type, a NW part ID and a UE part ID. The parameter “ReportModelLCMConfig” may indicate model inference and the parameter “resource” may indicate a first CSI-RS resource.

At 515, the NW 502 transmits a first CSI-RS on the first CSI-RS resource. At 516, CSI measurement is performed. That is, the UE 501 measures the first CSI-RS and obtains a first CSI. The first CSI may be in any suitable format, for example, in a format of legacy type I or type II codebook. Alternatively, the first CSI may be in a format with higher resolution.

At 518, CSI generation is performed using the UE part. That is, the UE 501 compresses the first CSI to a second CSI (e.g., CSI in compressed bits) using CSI generation part (which is the UE part). At 520, CSI reconstruction is performed using the NW part. Specifically, the UE reconstructs a third CSI based on the second CSI, using the matched CSI reconstruction part (which is the NW part).

Then at 522, the UE 501 may compare the first CSI and the third CSI, to obtain second information, e.g., the difference between the first CSI and the third CSI. The difference can be in following formats: codebook based, codebook selected from configured/defined differential codebook, an indication about the likelihood, 0/1 indication, an indication that associated CQI is overestimated/underestimated, the amplitude, phase, delay, frequency domain basis, spatial domain basis and so on of the difference, or the offset between the first CSI and the third CSI on amplitude, phase, delay, frequency domain basis, spatial domain basis and so on.

At 524, the UE 501 reports the second CSI. In addition, the UE 501 may report the second information. At 526, CSI reconstruction is performed using the NW part. Specifically, the NW 502 reconstructs a fourth CSI based on the reported second CSI by using the CSI reconstruction part, which is the NW part. In addition, at 528, the NW 502 may use the reported second information to correct the output of the AI/ML model (i.e., the fourth CSI) to obtain a fifth CSI.

In the case of training type 1 at the UE side, both the UE 501 and the NW 502 can be responsible for model monitoring. If the model monitoring is performed at the NW side, a “ground-truth” CSI is required to be reported. If the model monitoring is performed at the UE side, since the UE 501 has the NW part, only the performance is required to be reported. Signaling flow 500B comprises a flow 530 for monitoring at the UE side and a flow 540 for monitoring at the NW side.

The flow 530 can be considered as an example implementation of the flow 400B. For the flow 530 where the UE 501 performs the monitoring, the hierarchical configuration may include parameters “CSI-ReportForAI”, “ReportModelConfig”, “ReportModelLCMConfig”, “ReportConfig”, “ResourceConfig”, “dataset” or “resource”. The parameter “ReportModelConfig” may indicate or include a model ID and may additionally include or indicate a model type, a NW part ID and a UE part ID. The parameter “ReportModelLCMConfig” may indicate model monitoring and a monitoring method. The parameter “ReportConfig” may indicate the UE 501 to report a difference between the original CSI and a CSI reconstructed by at the UE side. The configuration may indicate a second CSI-RS resource, for example, by the parameters “ResourceConfig”, “resource set”, “resource”.

At 532, the NW 502 transmits the second CSI-RS to the UE 501. At 534, the UE 501 obtains sixth CSI by real measurement. Specifically, the UE 501 measures the second CSI-RS and obtains the sixth CSI. The sixth CSI may be in a format of legacy type I or type II codebook, or may be in a format with higher resolution. The sixth CSI can be treated as the “ground-truth”. At 536, the UE 501 obtains seventh CSI by applying the AI/ML model. That is, the UE 501 may compress the sixth CSI using the first part to get compressed CSI and reconstruct the seventh CSI from the compressed CSI using the NW part. Then, the UE 501 compares the sixth CSI and the seventh CSI, to obtain a difference between the sixth CSI and the seventh CSI as the third information, e.g., the model monitoring performance, which may correspond to the configured monitoring method. Possible monitoring method may include, but not limited to, based on inference accuracy, low confidence level, system performance degradation, input/output data out-of-distribution, input/output data distribution drift, mismatched application condition, low and/or no power/storage/computation resource, high complexity/latency, etc. At 538, the UE 501 may report the third information to the NW 502.

The flow 540 can be considered as an example implementation of the flow 400C. For the flow 540 where the UE 501 performs the monitoring, the hierarchical configuration may include parameters “CSI-ReportForAI”, “ReportModelConfig”, “ReportModelLCMConfig”, “ReportConfig”, “ResourceConfig”, “resource set”, “resource”. The parameter “ReportModelConfig” may indicate or include a model ID and may additionally include or indicate a model type, a NW part ID and a UE part ID. The parameter “ReportModeILCMConfig” may indicate model monitoring and additionally a monitoring method. The parameter “ReportConfig” may indicate the UE 501 to report an original CSI and a compressed CSI. The configuration may indicate a second CSI-RS resource.

At 546, the NW 502 transmits the second CSI-RS to the UE 501. At 542, the UE 501 obtains sixth CSI by real measurement. Specifically, the UE 501 measures the second CSI-RS and obtains the sixth CSI. The sixth CSI may be in a format of legacy type I or type II codebook, or may be in a format with higher resolution. The sixth CSI can be treated as the “ground-truth”. At 544, the UE 501 obtains eighth CSI using the UE part. That is, the UE 501 compresses, using the UE part, the sixth CSI to the eighth CSI, e.g., CSI in compressed bits. Then, the UE 501 reports the eighth CSI which is the compressed CSI and the sixth CSI as the “ground-truth” to the NW 502.

At 550, the NW 502 obtains ninth CSI using the NW part, that is, the CSI reconstruction part. Specifically, the NW 502 reconstructs the ninth CSI based on the eighth CSI by using the reconstruction part. At 552, the NE 502 compares the sixth CSI and the ninth CSI to get fourth information, which may be a difference between the sixth CSI and the ninth CSI. In other words, the NW 502 compares the sixth CSI and the ninth CSI to get information about the model performance, or information about the model monitoring results.

Through the above signaling flows 500A and 500B, joint training at a single side/entity (which is the training type 1 at the UE side) is supported.

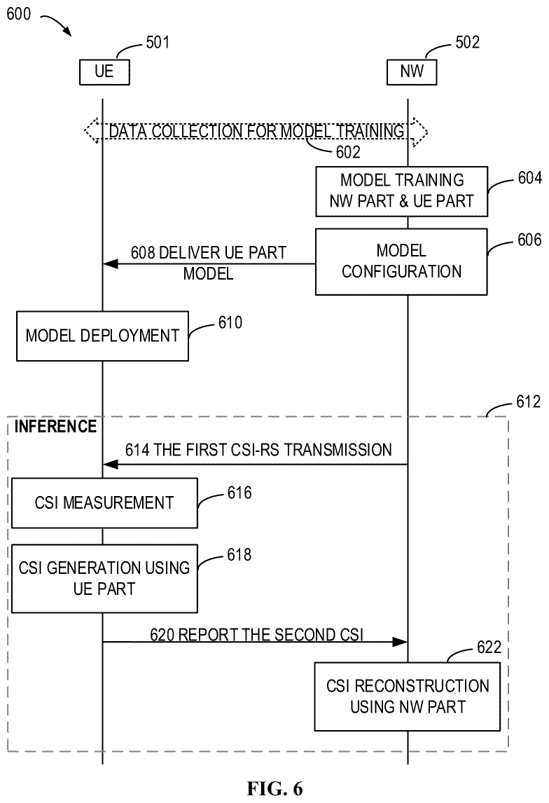

Reference is made to FIG. 6, which show the case of training type 1 at the NW side. Data collection for model training may be performed at 602. At 604, model training of the UE part and the NW part is performed at the NW 502. In other words, the NW 502 trains the CSI generation part (which is the UE part) and the CSI reconstruction part (which is the NW part) jointly. Alternatively, the NW 502 may obtain the AI/ML model from other entity. For online model training or model update, report may be needed from the UE 501 to collect data samples. The hierarchical configuration may include parameters “CSI-ReportForAI”, “ReportModelConfig”, “ReportModeILCMConfig”, “ReportConfig”, “ResourceConfig”, “resource set”, “resource”. The parameter “ReportModelConfig” may indicate or include a model ID, a NW part ID and a UE part ID. The parameter “ReportModelLCMConfig” may indicate model training/update, or, for data collection for model training/update and may additionally indicate a dataset ID. The parameter “ReportConfig” may indicate the UE 501 to report training CSI. The configuration may indicate a training CSI-RS resource.

After training is finished, at 608, the NW 502 delivers the UE part to the UE 501. In other words, the NW 502 shares the part of the trained AI/ML model, e.g., CSI generation part, to the UE 501. The transferred model(s) can be considered as registered for the UE 501. The NW 502 may assign ID(s) to the AI/ML model(s). In addition, the NW 502 may notify the UE 501 of the assigned ID(s). The UE 501 deploys the CSI generation part.

The flow 600 comprises a flow 612 for model inference. For the flow 612, the hierarchical configuration may include parameters “CSI-ReportForAI”, “ReportModelConfig”, “ReportModelLCMConfig”, “ReportConfig”, “ResourceConfig”, “resource set”, “resource”. The parameter “ReportModelConfig” may indicate or include a model ID, a NW part ID and a UE part ID. The parameter “ReportModelLCMConfig” may indicate model inference. The parameter “ReportConfig” may indicate the UE 501 to report compressed CSI. The configuration may indicate a first CSI-RS resource.

At 614, the NW 502 transmits a first CSI-RS on the first CSI-RS resource. At 616, CSI measurement is performed at the UE 501. That is, the UE 501 measures the first CSI-RS and obtains first CSI. The first CSI may be in any suitable format, for example, in a format of legacy type I or type II codebook. Alternatively, the first CSI may be in a format with higher resolution.

At 618, CSI generation is performed using the UE part at the UE 501. That is, the UE 501 compresses the first CSI to a second CSI (e.g., CSI in compressed bits) using CSI generation part (which is the UE part). At 620, the UE 501 reports the second CSI to the NW 502. At 622, the NW performs CSI reconstruction using the NW part. That is, the NW 502 reconstructs third CSI based on the reported second CSI.

In the case of training type 1 at the NW side, the NW 502 may be responsible for model monitoring, which means that the NW 502 performs the model motoring. Model monitoring may be the same as flow 540 and thus is not repeated.

Through the above signaling flow 600, joint training at a single side/entity (which is the training type 1 at the NW side) is supported.

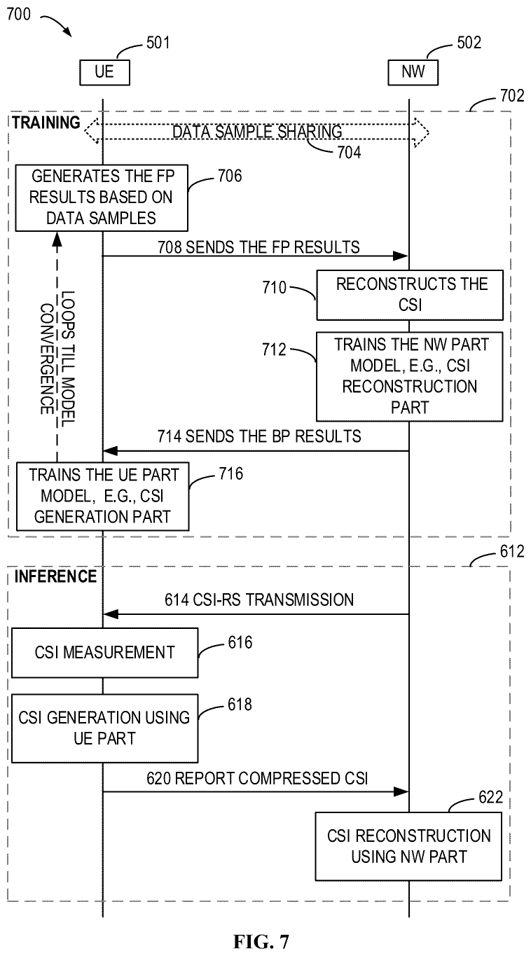

Reference is made to FIG. 7, which shows signaling flow 700 for the case of training type 2. The flow 702 for model training can be considered as an example implementation of the flow 400D. The hierarchical configuration may include parameters “CSI-ReportForAI”, “ReportModelConfig”, “ReportModelLCMConfig”, “ReportConfig”, “Dataset”. The parameter “ReportModelConfig” may indicate or include a model ID, a NW part ID and a UE part ID. The parameter “ReportModelLCMConfig” may indicate model training/update, or, for data collection for model training/update. The parameter “ReportConfig” may indicate the UE 501 to report FP results. The parameter “Dataset” may indicate a dataset ID.

Data sample sharing between the UE 501 and the NW 502 may be performed at 704. At 706, the UE 501 generates the FP results (i.e., CSI feedback) based on the data sample(s). At 708, the UE 501 sends the FP results to the NW 502. At 710, the NW 502 reconstructs the CSI based on the FP results. Then, at 712, the NW 502 trains the NW part, e.g., the CSI reconstruction part. Accordingly, the NW 502 generates the BP results (e.g., gradients), which at 714 are sent to the UE 501. At 716, the UE 501 trains the UE part, e.g., the CSI generation part, based on the BP results from the NW 502.

No model transfer is needed in this case. The trained model(s) can be considered as registered for the UE 501. The NW 502 may assign ID(s) to the AI/ML model(s), and may additionally notify the UE 501.

Model inference is the same as the flow 612 and thus is not repeated. In the case of training type 2, the NW 502 may be responsible for model monitoring, which means that the NW 502 performs the model motoring. Model monitoring may be the same as flow 540 and thus is not repeated.

Through the above the signaling flow 700, joint training of the two-sided model at network side and UE side, respectively (which is the training type 2) is supported.

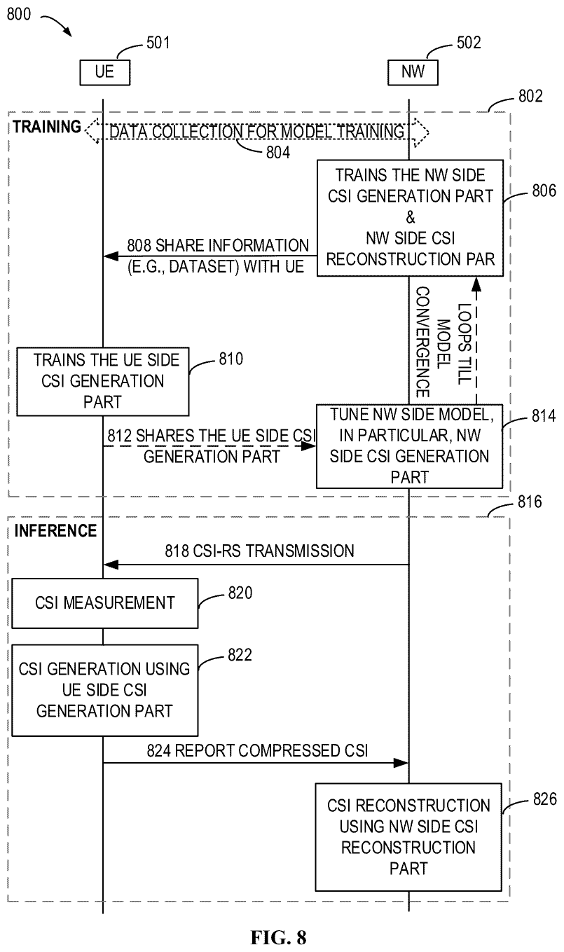

Reference is now made to FIG. 8, which shows signaling flow 800 for the use of training type 3 starting with the NW side training. The flow 802 for model training can be considered as an example implementation of the flow 400E. Specifically, data collection for model training may be performed at 804.

At 806, the NW 502 trains the NW side CSI generation part (which is not used for inference) and the NW side CSI reconstruction part jointly. After training is finished, the NW 502 shares the UE 501 with a set of information (e.g., dataset) that is used by the UE 501 to be able to train the UE side CSI generation part. In addition, the shared information may include reference model, reference UE part model, reference NW part model, quantization/dequantization methods applied at the UE 501 and/or the NW 502, etc.

At 810, the UE 501 trains the UE side CSI generation part based on the received set of information. At this stage, the UE side CSI generation part may not be exactly as same as the NW side CSI generation part. To this end, an alignment between the UE and NW is needed. At 812, the UE 501 may share the UE side CSI generation part with the NW 502. For example, the UE 501 may send information about the UE side CSI generation part to the NW 502. At 814, the NW 502 may tune the NW side model, in particular, the NW side CSI generation part. Training of the NW side CSI generation part and the NW side CSI reconstruction part may be performed iteratively until model convergence.

The flow 800 comprises a flow 816 for model inference. For the flow 816, the hierarchical configuration may include parameters “CSI-ReportForAI”, “ReportModelConfig”, “ReportModelLCMConfig”, “ReportConfig”, “ResourceConfig”, “resource set”, “resource”. The parameter “ReportModelConfig” may indicate or include a model ID, a NW part ID and a UE part ID. The parameter “ReportModelLCMConfig” may indicate model inference. The parameter “ReportConfig” may indicate the UE 501 to report compressed CSI.

At 818, the NW 502 transmits a first CSI-RS on the first CSI-RS resource. At 820, CSI measurement is performed at the UE 501. That is, the UE 501 measures the first CSI-RS and obtains first CSI. The first CSI may be in any suitable format, for example, in a format of legacy type I or type II codebook. Alternatively, the first CSI may be in a format with higher resolution.

At 822, CSI generation is performed using the UE side CSI generation part. That is, the UE 501 compresses the first CSI using the UE side CSI generation part. At 824, the UE 501 reports the compressed CSI to the NW 502. At 826, the NW performs CSI reconstruction using the NW side CSI reconstruction part. That is, the NW 502 reconstructs the CSI based on the compressed CSI.

In the case of training type 3, the NW 502 may be responsible for model monitoring, which means that the NW 502 performs the model motoring. Model monitoring may be the same as flow 540 and thus is not repeated.

Through the above the signaling flow 700, the two-sided AI/ML model which is separately trained at network side and UE side (corresponding to training type 3, NW-first) is supported.

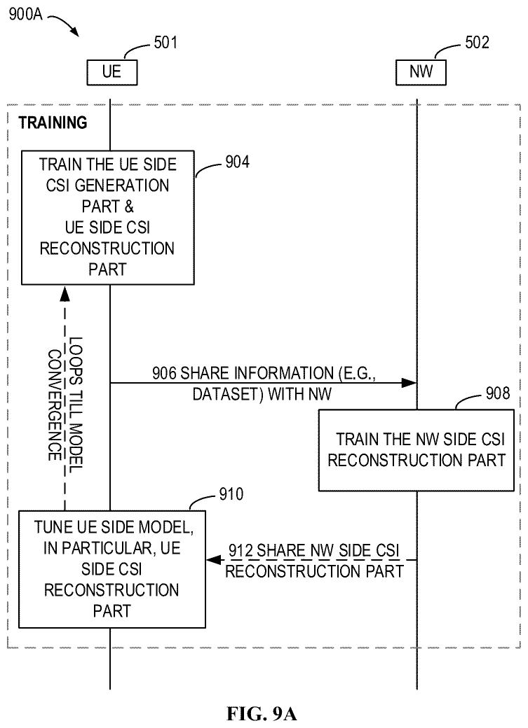

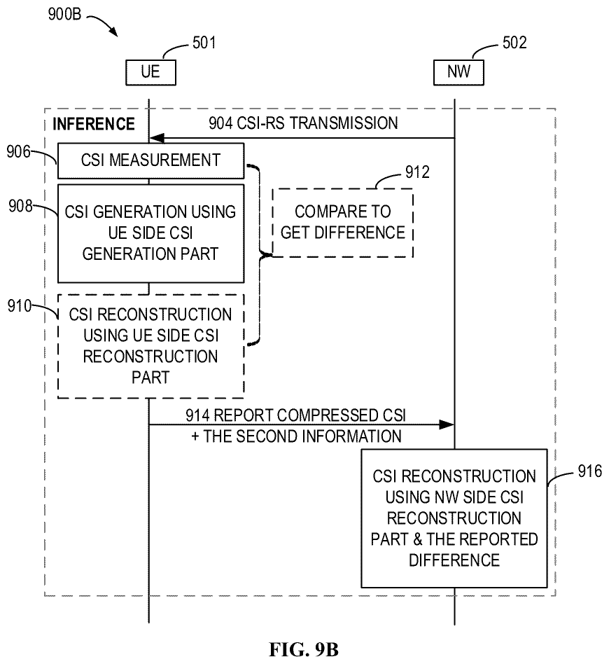

Reference is now made to FIG. 9A and FIG. 9B, which show signaling flows 900A and 900B in the case of training type 3 starting with terminal side training. The flow 900A for model training can be considered as an example implementation of the flow 400F.

At 904, the UE 501 trains the UE side CSI generation part and the UE side CSI reconstruction part (which is not used for inference) jointly. After the UE side training is finished, the UE 501 shares the NW 502 with a set of information (e.g., dataset) that is used by the NW 502 to be able to train the CSI reconstruction part. In addition, the shared information may include reference model, reference UE part model, reference NW part model, quantization/dequantization methods applied at the UE 501 and/or the NW 502, etc.

The NW 501 trains the NW side CSI reconstruction part based on the received set of information. At this stage, the UE side CSI reconstruction part may not be exactly as same as NW side CSI reconstruction part. To this end, an alignment between the UE side and the NW side is needed. At 912, the NW 502 may share NW side CSI reconstruction part with the UE 501. For example, the NW 502 may send information about the NW side CSI reconstruction part to the UE 501.

At 910, the UE 501 may tune the UE side model, in particular, the UE side CSI reconstruction part. Training of the UE side CSI generation part and the UE side CSI reconstruction part may be performed iteratively until model convergence.

The flow 900B for model inference can be considered as an example implementation of the flow 400A. The hierarchical configuration may include parameters “CSI-ReportForAI”, “ReportModelConfig”, “ReportModelLCMConfig”, “ReportConfig”, “ResourceConfig”, “resource set”, “resource”. The parameter “ReportModelConfig” may indicate or include a model ID and may additionally include or indicate a model type, a NW part ID and a UE part ID. The parameter “ReportModelLCMConfig” may indicate model inference and the parameter “resource” may indicate a first CSI-RS resource.

At 904, the NW 502 transmits a first CSI-RS on the first CSI-RS resource. At 906, CSI measurement is performed. That is, the UE 501 measures the first CSI-RS and obtains a first CSI. The first CSI may be in any suitable format, for example, in a format of legacy type I or type II codebook. Alternatively, the first CSI may be in a format with higher resolution.

At 908, CSI generation is performed using the UE side CSI generation part. That is, the UE 501 compresses the first CSI to a second CSI (e.g., CSI in compressed bits) using UE side CSI generation part. At 910, CSI reconstruction is performed using the UE side CSI reconstruction part. Specifically, the UE reconstructs a third CSI based on the second CSI, using the matched UE side CSI reconstruction part.

Then at 912, the UE 501 may compare the first CSI and the third CSI, to obtain second information, e.g., the difference between the first CSI and the third CSI. The difference can be in following formats: codebook based, codebook selected from configured/defined differential codebook, an indication about the likelihood, 0/1 indication, an indication that associated CQI is overestimated/underestimated, the amplitude, phase, delay, frequency domain basis, spatial domain basis and so on of the difference, or the offset between the first CSI and the third CSI on amplitude, phase, delay, frequency domain basis, spatial domain basis and so on.

At 914, the UE 501 reports the second CSI, which is the compressed CSI. In addition, the UE 501 may report the second information. At 916, CSI reconstruction is performed using the NW side CSI reconstruction part and the reported second information, for example, the reported difference between the first CSI and the third CSI. Specifically, the NW 502 reconstructs a fourth CSI based on the reported second CSI by using the NW side CSI reconstruction part. The NW 502 may use the reported second information to correct the output of the AI/ML model (i.e., the fourth CSI) to obtain a fifth CSI.

In the case of training type 3 starting with the UE side training, both the UE 501 and the NW 502 can be responsible for model monitoring. Model monitoring may be the same as flow 503 or flow 540 and thus is not repeated.

Through the above the signaling flows 900A and 900B, the two-sided AI/ML model which is separately trained at network side and UE side (corresponding to training type 3, UE-first) is supported.

### Example Signaling flow For Model Alignment

As mentioned above, in some embodiments, the AI/ML model may be a two-sided model. Therefore, the AI/ML model may include a first component used by the terminal device 110 and a second component used by the network device 120. In some embodiments, the first component may be the first part and the second component may be the second part, as described with reference to FIG. 1B. For example, in the case of CSI feedback, the first part may be the CSI generation part and the second part may be the CSI reconstruction part.

Alternatively, in some embodiments, the first component may be a quantization module for converting values into bits and the second component may be a dequantization module for converting bits into values. For example, quantization may refer to a conversion from measured results to indexes for report, or a conversion from inferred results to indexes for report. Dequantization may refer to a conversion from reported indexes to measurement results, or a conversion from reported indexes to inference results. The quantization module employs a quantization method and the dequantization module employs a dequantization method. The quantization module may be a portion of the CSI generation part, in particular, the last portion of the CSI generation part. The dequantization module may be a portion of the CSI reconstruction part, in particular, the first portion of the CSI reconstruction part.

With respect to the combination of the first and second components, there may be three cases. In a case 1, there may be multiple candidates for the first component and one candidate for the second component. In a case 2, there may be one candidate for the first component and multiple candidates for the second component. In a case 3, there may be multiple candidates for the first component and multiple candidates for the second component.

In any of the above cases, the selection for the first component and/or the second component is needed to align the first component and the second component, in order to achieve model alignment, or in other words, model matching.

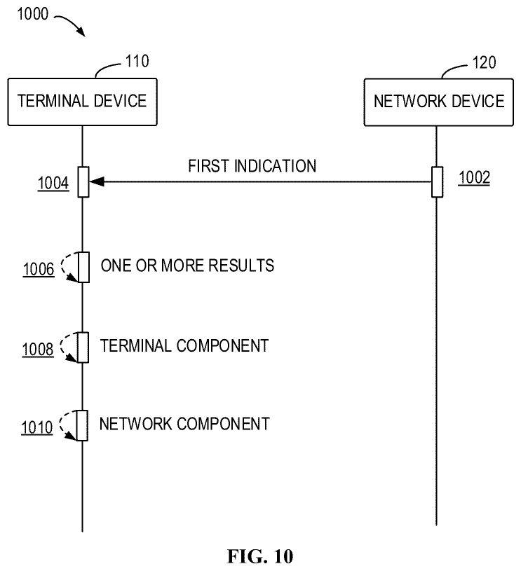

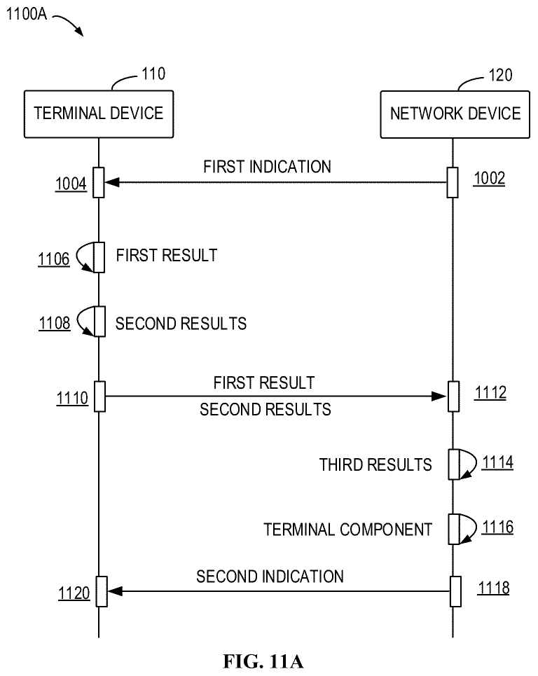

Reference is made to FIG. 10, which illustrates a signaling flow 1000 of model alignment in accordance with some embodiments of the present disclosure. For the purposes of discussion, the signaling flow 1000 will be discussed with reference to FIG. 1B, for example, by using the terminal device 110 and the network device 120.

The network device 120 transmits 1002, to the terminal device 110, a first indication to select at least one of the first component and the second component. In some embodiments, the first indication may be comprised in a dedicated signaling, for example, may be signaled via a separated parameter. Alternatively, in some embodiments, the first indication may be comprised in the hierarchical configuration as described above. For example, the first indication may be implicitly signaled via the parameter of the first level which indicates the model.

The terminal device 110 receives 1004 the first indication from the network device 120. Depending on specific content of the first indication, the terminal device 110 may perform one or more operations. In some embodiment, the terminal device 110 may determine 1006 one or more results associated with a measurement. For example, in the case of CSI feedback, the terminal device 110 may determine one or more versions of CSI. The one or more results may be at least partially transmitted to the network device 120.

Alternatively, or in addition, in some embodiments, the terminal device 110 may determine 1008 terminal component to be used as the first component. Specifically, there may be a plurality of terminal component as candidates for the first component. In the following, a terminal component which is a candidate for the first component is also referred to as a candidate terminal component. The terminal device 110 may select the terminal component to be used from the candidate terminal components.

Alternatively, or in addition, in some embodiments, the terminal device 110 may determine 1010 a network component to be used as the second component. Specifically, there may be a plurality of network component as candidates for the second component. In the following, a network component which is a candidate for the second component is also referred to as a candidate network component. The terminal device 110 may select the network component to be used from the candidate network components. In such embodiments, the terminal device 110 may further notify the network device 120 of the selected network device.

In some embodiments, the terminal device 110 may transmit capability information to the network device 120. The capability information indicates a number or a maximum supported number of candidate terminal components for an AI/ML model, or for a network component, or in total. The capability information further indicates a number or a maximum supported number of candidate network components for an AI/ML model, or for a terminal component, or in total. Alternatively, or in addition, in some embodiments, the network device 120 may transmit, to the terminal device 110, a configuration indicating a number of candidate terminal components and a number of candidate network components. In this way, the terminal device 110 and the network device 120 can be aware of the candidate components. Moreover, it is to be understood that the flow 1000 can be valid for training collaboration type that requires separated training or joint training.

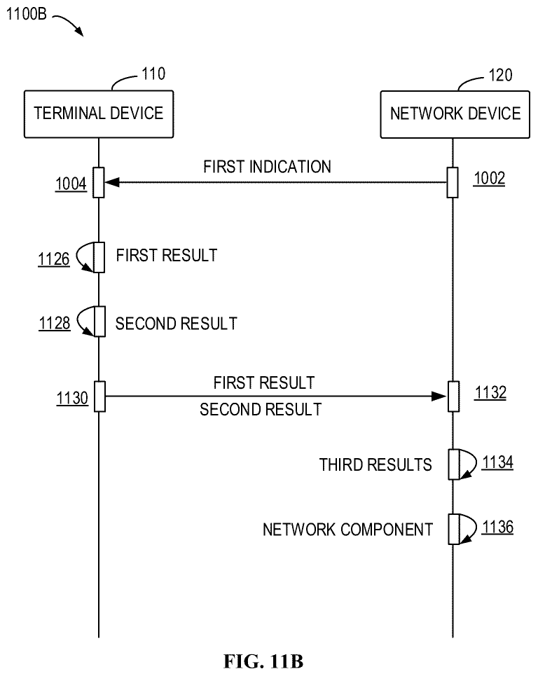

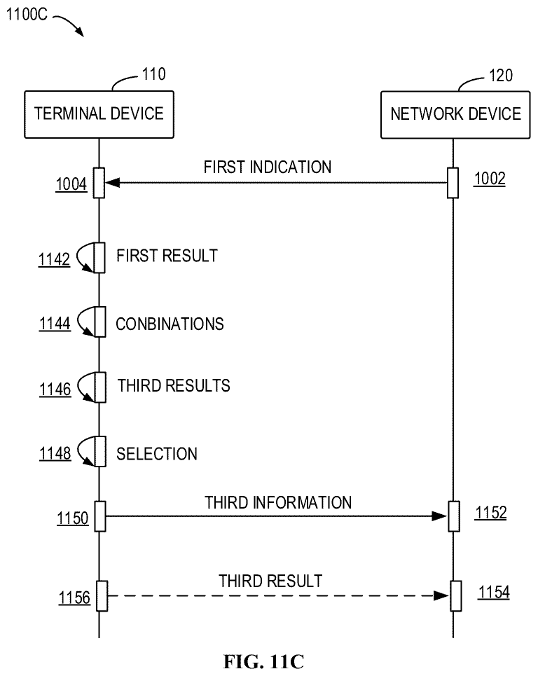

Reference is now made to FIGS. 11A to 11C to illustrate example interactions between the terminal device 110 and the network device 120 in different cases. Acts with the same reference sign as FIG. 10 are the same and thus descriptions thereof are not repeated.

In some embodiments, for example in the case 1 as mentioned above, there may be multiple candidates for the first component and one candidate for the second component. In other words, the second component is fixed or predetermined, or selection for the first component is required. FIG. 11A shows a signaling flow 1100A in the case 1. In such embodiments, the first indication may indicate that the terminal component is to be selected for using with the second component. In other words, the first indication may indicate that the network component is fixed or predetermined. Alternatively, the first indication may indicate that different candidate terminal components are to be used to generate measurement report, for example CSI report.

In response to the first indication, the terminal device 110 obtains 1106 a first result for a measurement by measuring a resource. That is, the terminal device 110 obtains an original result by performing real measurement. Then, the terminal device 110 generates 1108 a plurality of second results based on the first result by using a plurality of candidate terminal components, respectively. For example, the first result may be input into the plurality of candidate terminal components, each of which outputs a second result. Then, the terminal device 110 transmits 1110 the first result and the plurality of second results to the network device 120.

In some embodiments, the plurality of candidate terminal component for generating the plurality of second results may be a subset of all the candidate terminal component for the first component. Accordingly, the terminal device 110 may transmit to the network device 120 first information concerning the plurality of terminal components for generating the plurality of second results.

The network device 120 receives the first result and the plurality of second results from the terminal device 110. In some embodiments, the network device 120 may further receive the first information from the terminal device 110. The network device 120 then generates 1114, by using the second component which is fixed or predetermined, a plurality of third result based on the plurality of second results, respectively. For example, each of the plurality of second results is processed by the second component to generate a third result. The network device 120 compares the first result with each of the plurality of third results and selects 1116 a terminal component from the plurality of candidate terminal components based on the comparison. For example, the third result generated by the selected terminal component may be closest to the first result among the plurality of third results. Then, the network device 120 transmits 1118, to the terminal device 110, a second indication of the selected terminal component. The second indication may be an ID of the selected terminal component or information available for accessing the selected terminal component.

The terminal device 110 receives 1120 the second indication from the network device 120. Afterwards, the selected terminal component is used as the first component for model inference, model monitoring, etc.

In the flow 1100A, the first result and the second results are transmitted to the network device 120 and the first component is selected by the network device 120. Alternatively, in some embodiments, the terminal device 110 may select the first component on its own.

In some embodiments, for example in the case 2 as mentioned above, there may be one candidate for the first component and multiple candidates for the second component. In other words, the first component is fixed or predetermined, or selection for the second component is required. FIG. 11B shows a signaling flow 1100B in the case 2. In such embodiments, the first indication may indicate that a network component is to be selected for using with the first component. In other words, the first indication may indicate that the terminal component is fixed or predetermined. Alternatively, the first indication may indicate that different candidate network components are to be used to generate measurement report, for example CSI report.

In response to the first indication, the terminal device 110 obtains 1126 a first result for a measurement by measuring a resource. That is, the terminal device 110 obtains an original result by performing real measurement. Then, the terminal device 110 generates 1128 a second result based on the first result by using the first component. For example, the first result may be input into the first component, which outputs the second result. Then, the terminal device 110 transmits 1110 the first result and the second result to the network device 120.

In some embodiments, the terminal device 110 may additionally transmit to the network device 120 second information concerning the first component for generating the second result.

The network device 120 receives 1132 the first and second results from the terminal device 110. Then, the network device 120 generates 1134 a plurality of third results based on the second result by using a plurality of candidate network components, respectively. For example, the second result may be input to the plurality of candidate network components, each of which output a third result.

The network device 120 compares the first result with each of the plurality of third results and selects 1136 a network component from the plurality of candidate network components based on the comparison. For example, the third result generated by the selected network component may be closest to the first result among the plurality of third results. Then, the network device 120 uses the selected network component as the second component for model inference, model monitoring, etc.

In the flow 1100B, the first result and the second result are transmitted to the network device 120 and the second component is selected by the network device 120. Alternatively, in some embodiments, the terminal device 110 may select the second component for the network device 120 and notify the network device 120 of the selected component. In such embodiment, the terminal device 110 is aware of the candidate network components, for example, via an indication or a configuration from the network device 120.

In some embodiments, for example in the case 3 as mentioned above, there may be multiple candidates for the first component and multiple candidates for the second component. In other words, selection for both the first component and the second component is required, or a combination (for example, a best combination) of terminal component and network component is needed to be determined. FIG. 11C shows a signaling flow 1100C in the case 3. In such embodiments, the first indication may indicate the terminal device 120 to report the network component. In other words, the first indication may indicate the terminal device 110 to determine a combination (for example, a best combination) of terminal component and network component.

In response to the first indication, the terminal device 110 obtains 1142 a first result for a measurement by measuring a resource. That is, the terminal device 110 obtains an original result by performing real measurement. Then, the terminal device 110 determines 1144 a plurality of combinations of terminal and network components based on a plurality of candidate network components and a plurality of candidate terminal components. For example, a candidate terminal network component may be combined with each candidate network component, resulting in a complete model.

The terminal device 110 then generates a plurality of third results based on the first result by using the plurality of combinations, respectively. For example, the plurality of combinations may correspond to a plurality of complete models. The first result is input into the plurality of complete models, each of which outputs a third result.

Then, the terminal device 110 compares the plurality of third results and the first result. Based on the comparison, the terminal device 110 selects 1148 a network component from the plurality of network components and the terminal component from the plurality of terminal components. In other words, the terminal device 110 selects a combination of terminal component and network component. For example, the third result generated by the selected combination may be closest to the first result among the plurality of third results.

The terminal device 110 transmits 1150, to the network device 120, third information concerning the selected network component. The network device 120 receives 1152 the third information from the terminal device 110. Afterwards, the terminal device 110 uses the selected terminal component for model inference, model monitoring, etc. Similarly, the network device 120 uses the selected network component for model inference, model monitoring, etc.

In some embodiments, the terminal device 110 may additionally transmit 1156 the third result generated by using the selected combination to the network device 120. The network device 120 may receive 1154 the third result from the terminal device 110. In this way, measurement report is achieved. Although shown separately, the third result and the third information may be transmitted together.

It is to be understood that the signaling flows 400E and 400F described above may be used for the purpose of model alignment as well.

The cost (for example, the time length, computation resources, complicity, or power consumption) required for model alignment or selection may depend on the number of candidate terminal components and/or the number of candidate network components. In addition or alternatively, the cost may also depend on the first indication.

A larger time length may be needed if terminal component selection is involved. In some embodiments, the time length(s) may be candidate value(s) of the expiry of a timer configured for model alignment. The timer may start at the time point of reception, acknowledgement or application of the first indication. The timer may stop/reset when model alignment is accomplished, or the terminal/network component is selected or related singalling is transmitted/received.

Some example embodiments have been described above with reference to FIGS. 10 to 11C. According to these embodiments of the present disclosure, the component for using by the terminal device and the component for using by the network device can be matched for the two-sided model.

### Example Use Cases for Model Alignment

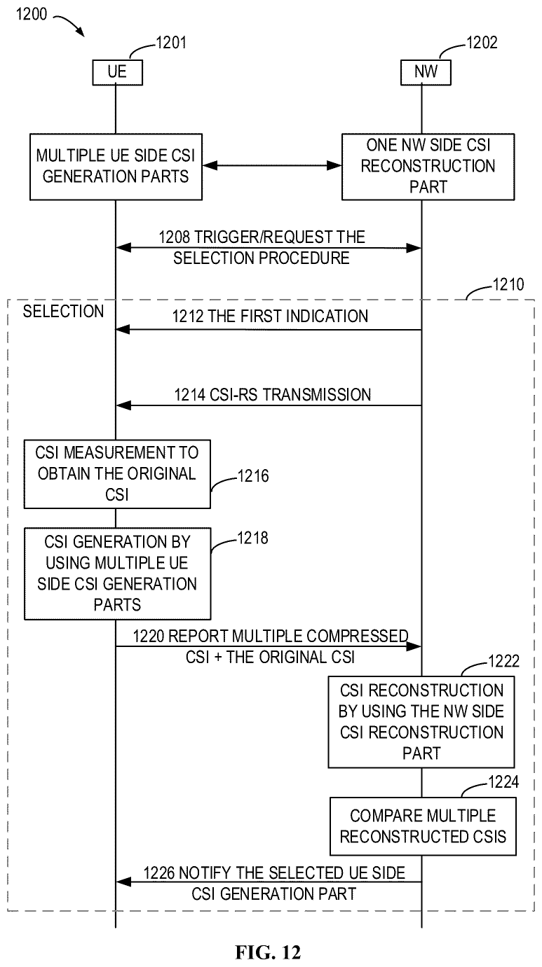

To better understand the solution for model alignment, reference is made to FIGS. 12 to 14 to illustrate some example use cases. In these example use cases, the AI/ML model is used for CSI feedback, the UE 1201 is an example of the terminal device 110, and the NW 1202 is an example of the network device 120. Accordingly, the UE part or UE side CSI generation part is an example of the first component and the NW part or the NW side CSI reconstruction part is an example of the second component.

Reference is first made to FIG. 12, which show flow 1200 in the case of UE first-alignment. It is assumed that for one two-sided AI/ML model, there exist multiple CSI generation parts for one CSI reconstruction part.

At 1208, trigger or request for the model selection procedure is performed. For example, the NW 1202 may trigger the model selection procedure, via dedicated signaling. Alternatively, the UE 1201 may request the model selection procedure. Then, the flow 1210 for model selection is performed. The flow 1210 can be considered as an example implementation of the flow 1100A.

Specifically, at 1212, the UE 1201 is provided a first indication that the NW part of the model is fixed, for model selection. In other words, the UE 1201 is provided with an indication that using different UE parts to generate CSI report. The first indication may be signaled explicitly via a separated parameter. Alternatively, the first indication may signaled be via the hierarchical configuration for model management as described above, e.g., implicitly signaled via configuring one NW part ID and without UE part ID.

As an example, the hierarchical configuration may include, but not limited to: a parameter “CSI-ReportForAI”; a parameter “ReportModelConfig” which includes or indicates a model ID, and one NW part ID; O a parameter “ReportModelLCMConfig” indicating model selection; a parameter “ReportConfig” which indicates the terminal device 110 to report multiple compressed CSIs, the original CSI, and additionally the number of compressed CSIs; a parameter “ResourceConfig”; a parameter “resource set” and a parameter “resource”. It is to be noted that the number of compressed CSIs may equal to or be no larger than the number of CSI generation parts.

At 1214, the NW 1202 transmits a CSI-RS on a CSI-RS resource. At 1216, the UE 1201 measures the CSI-RS to obtain the original CSI. At 1218, based on the first indication, the UE 1201 generates multiple compressed CSIs using multiple UE side CSI generation parts, respectively. For example, the original CSI is input into the multiple UE side CSI generation parts, each of which generate the compressed CSI.

At 1220, in addition to the original CSI, the UE 1201 reports the multiple compressed CSIs. In some embodiments, if the UE 1201 only generates compressed CSI using a subset of the UE parts, information about the applied UE parts may also be reported to the NW 1202.

At 1222, the NW 1202 reconstructs multiple CSIs using the fixed or predetermined NW side CSI reconstruction part. For example, the reported compressed CSIs are input into the NW side CSI reconstruction part to obtain the multiple reconstructed CSIs. At 1224, the NW 1202 compares the multiple reconstructed CSIs with the original CSI and select a UE side CSI generation part. For example, the NW 1202 may determine the selection of best matched UE part, e.g., by comparing the performance of different combinations of UE part and NW part, considering the original CSI has been reported. At 1226, the UE 1201 is provided with an indication of the selected UE side generation part for model selection and for the NW part model.

Through the flow 1200, model alignment in the case of UE first alignment is supported. In this way, the UE part best matched with the NW part can be selected and used for model inference.

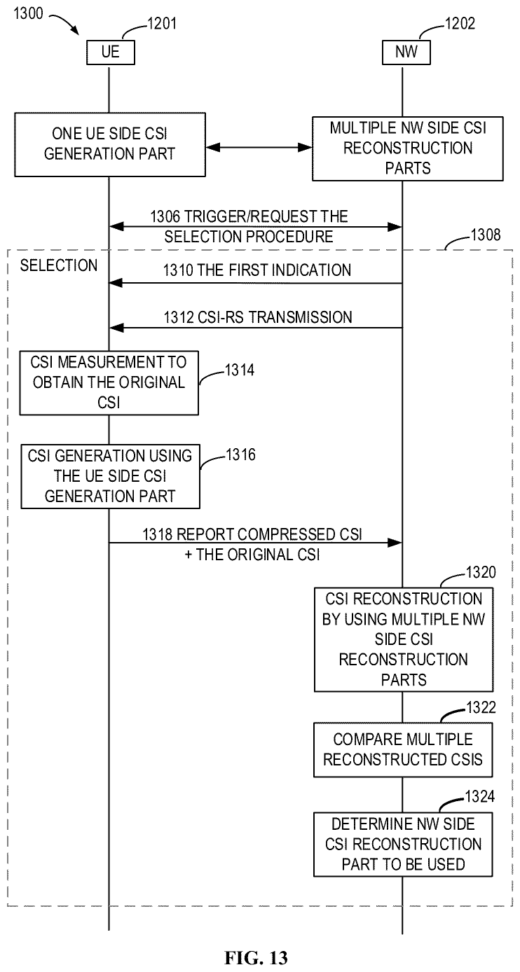

Reference is made to FIG. 13, which show flow 1300 in the case of NW first-alignment. It is assumed that for one two-sided AI/ML model, there exist one CSI generation parts for multiple CSI reconstruction parts.

At 1306, trigger or request for the model selection procedure is performed. For example, the NW 1202 may trigger the model selection procedure, via dedicated signaling. Alternatively, the UE 1201 may request the model selection procedure. Then, the flow 1308 for model selection is performed. The flow 1308 can be considered as an example implementation of the flow 1100B.

Specifically, at 1310, the UE 1201 is provided a first indication that the UE part shall fixed at least for the indicated NW part. In other words, the UE 1201 is provided with an indication that the NW 1202 may use different NW parts to reconstruct the CSI. The first indication may be signaled explicitly via a separated parameter. Alternatively, the first indication may signaled be via the hierarchical configuration for model management as described above, e.g., implicitly signaled via configuring one UE part ID.

As an example, the hierarchical configuration may include, but not limited to: a parameter “CSI-ReportForAI”; a parameter “ReportModelConfig” which includes or indicates a model ID, and additionally one UE part ID; a parameter “ReportModelLCMConfig” indicating model selection; a parameter “ReportConfig” which indicates the terminal device 110 to report compressed CSI, and additionally the original CS; a parameter “ResourceConfig”; a parameter “resource set” and a parameter “resource”.

At 1312, the NW 1202 transmits a CSI-RS on a CSI-RS resource. At 1314, the UE 1201 measures the CSI-RS to obtain the original CSI. At 1316, the UE 1201 generates compressed CSI using the fixed UE side CSI generation part. At 1318, the UE 1201 reports the compressed CSI and may additionally report the original CSI. In addition, if multiple UE side CSI generation parts exist and no UE part ID in the first indication, the UE 1201 may report the applied UE part ID to the NW 1202.

At 1320, the NW 1202 reconstructs multiple CSIs using the multiple NW side CSI reconstruction parts. For example, the reported compressed CSI is input into the multiple NW side CSI reconstruction parts to generate the multiple CSIs. At 1322, the NW 1202 compares the multiple reconstructed CSIs and the original CSI and at 1324, the NW 1202 determines the NW side CSI reconstruction part to be used. For example, the NW 1202 may determine the selection of the best matched NW part, e.g., by comparing the performance of different combinations of the UE part and NW parts, considering the original CSI has been reported.

Through the flow 1300, model alignment in the case of NW first alignment is supported. In this way, the NW part best matched with the UE part can be selected and used for model inference.

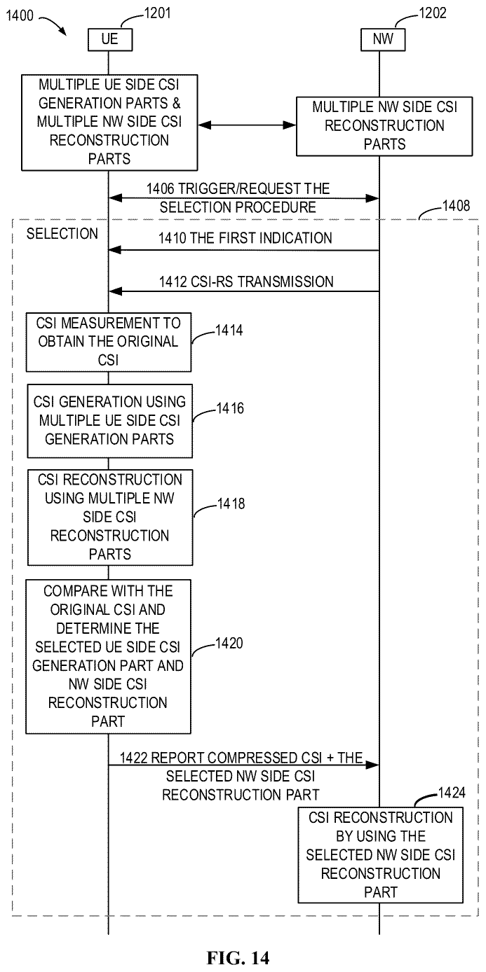

Reference is made to FIG. 14, which show a flow 1400 in the case of NW-determined alignment. It is assumed that for one two-sided AI/ML model, there exist multiple CSI generation parts for multiple CSI reconstruction parts and that the UE 1201 has all the information about multiple CSI reconstruction parts.

At 1406, trigger or request for the model selection procedure is performed. For example, the NW 1202 may trigger the model selection procedure, via dedicated signaling. Alternatively, the UE 1201 may request the model selection procedure. Then, the flow 1408 for model selection is performed. The flow 1408 can be considered as an example implementation of the flow 1100C.

Specifically, at 1310, the UE 1201 is provided a first indication that the UE 1201 reports the selected NW part, for model selection. In other words, the UE 1201 is provided with an indication that it shall determine the best combination of the UE part and the NW part. The first indication may be signaled explicitly via a separated parameter. Alternatively, the first indication may signaled be via the hierarchical configuration for model management as described above, e.g., implicitly signaled via configuring one UE part ID.

As an example, the hierarchical configuration may include, but not limited to: a parameter “CSI-ReportForAI”; a parameter “ReportModelConfig” which includes or indicates a model ID; a parameter “ReportModelLCMConfig” indicating model selection; a parameter “ReportConfig” which indicates the terminal device 110 to report corresponding NW part; a parameter “ResourceConfig”; a parameter “resource set” and a parameter “resource”.

At 1412, the NW 1202 transmits a CSI-RS on a CSI-RS resource. At 1414, the UE 1201 measures the CSI-RS to obtain the original CSI. At 1416, based on the first indication, the UE 1201 generates multiple compressed CSIs using multiple UE side CSI generation parts, respectively. For example, the original CSI is input into the multiple UE side CSI generation parts, each of which generate the compressed CSI.

The UE 1201 determines the selection of best matched UE part and NW part combinations, e.g., by comparing the performance of different combinations of UE part and NW part, considering the original CSI and the NW part models are all known at UE side. Specifically, at 1418, the UE 1201 reconstructs multiple CSIs using the multiple NW side CSI reconstruction parts. For example, each of the compressed CSIs is input into the multiple NW side CSI reconstruction parts to generate the multiple reconstructed CSIs. CSI of the multiple reconstructed CSIs corresponds to a combination of UE part and NW part. At 1420, the UE 1201 compares the multiple reconstructed CSIs and the original CSI and determines the selected UE side CSI generation part and NW side CSI reconstruction part to be used.

At 1422, the UE 1201 reports the selection of matched NW part. In addition, the UE 1201 may report compressed CSI corresponding to the combination of the best matched UE part and NW part. At 1424, the NW 1202 reconstructs CSI using the reported NW side CSI reconstruction part.

Through the flow 1400, model alignment in the case of UE-determined alignment is supported. In this way, the best matched UE and NW part model can be selected and used for model inference.

It is to be understood that the example flows 1200, 1300, and 1400 described above can be employed for other types of components of the AI/ML model, for example the quantization module and the dequantization module. Therefore, the UE part or UE side CSI generation part in the example flows 1200, 1300, and 1400 can be replaced by the quantization module or the quantization method. Meanwhile, the NW part or NW side CSI reconstruction part in the example flows 1200, 1300, and 1400 can be replaced by the dequantization module or the dequantization method. In this way, the issue of unaligned quantization and dequantization methods at UE and NW side can be solved.

### Example Methods and Devices

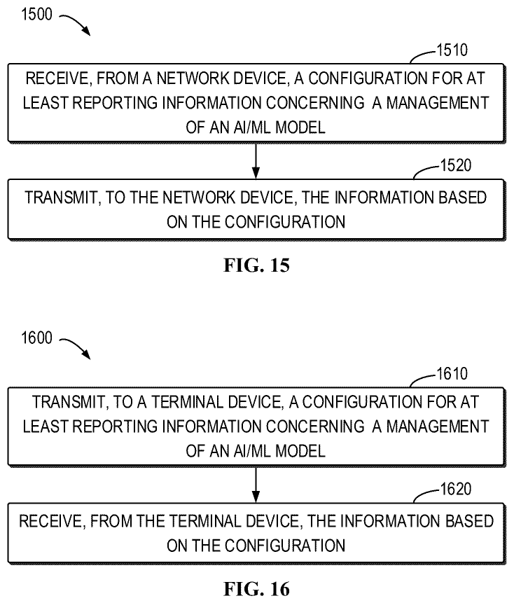

FIG. 15 illustrates a flowchart of a communication method 1500 implemented at a terminal device in accordance with some embodiments of the present disclosure. For the purpose of discussion, the method 1500 will be described from the perspective of the terminal device 110 in FIG. 1B.

At block 1510, the terminal device receives, from a network device, a configuration for at least reporting information concerning a management of an AI/ML model. The configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset.

At block 1520, the terminal device transmits, to the network device, the information based on the configuration.

In some example embodiments, the configuration is further used for reporting a result for a measurement and the parameters of the plurality of levels further comprise at least one of the following: one or more parameters of a fourth level indicating a resource for the terminal device to perform the measurement, or one or more parameters of a fifth level of parameters indicating a scheme for reporting the information and the result.

In some example embodiments, the AI/ML model comprises a first part for using by the terminal device and a second part for using by the network device, and the configuration indicates model interference. The terminal device may obtain a first result for a measurement by measuring on a first resource indicated by the configuration; generate a second result based on the first result by using the first part; generate a third result based on the second result by using a terminal version of the second part; and transmit, to the network device, the second result and a first difference between the first and third results.

In some example embodiments, the AI/ML model comprises a first part for using by the terminal device and a second part for using by the network device, and the configuration indicates model monitoring. The terminal device may obtain a sixth result for a measurement by measuring a second resource indicated by the configuration; generate a seventh result based on the sixth result by using the first part and a terminal version of the second part; and transmit, to the network device, at least a second difference between the sixth and seventh results.

In some example embodiments, the AI/ML model comprises a first part for using by the terminal device and a second part for using by the network device, and the configuration indicates model monitoring. The terminal device may obtain a sixth result for a measurement by measuring a second resource indicated by the configuration; generate an eighth result based on the sixth result by using the first part; and transmit the sixth and eighth results to the network device.

In some example embodiments, the AI/ML model comprises a first part for using by the terminal device and a second part for using by the network device, and the configuration indicates model training. The terminal device may generate a forward propagation result based on a training sample by using the first part; transmit the forward propagation result to the network device; receive a backward propagation result from the network device, the backward propagation result generated based on the forward propagation result and the training sample by using the second part; and update the first part based on the backward propagation result.

In some example embodiments, the AI/ML model comprises a first part for using by the terminal device and a second part for using by the network device, and the configuration indicates model training. The terminal device may receive, from the network device, first training information concerning the first part; train a terminal version of the first part based on the training information; and transmit information concerning the terminal version of the first part to the network device.

In some example embodiments, the AI/ML model comprises a first part for using by the terminal device and a second part for using by the network device, and the configuration indicates model training. The terminal device may train the first part and a terminal version of the second part; transmit, to the network device, second training information concerning the second part; receive, from the network device, information concerning a network version of the second part trained based on the second training information; and update, based on the network version, at least one of the first part and the terminal version of the second part.

In some example embodiments, the configuration comprises an indication to select at least one of a first component of the AI/ML model or a second component of the AI/ML model, the first component is used by the terminal device, and the second component is used by the network device.

FIG. 16 illustrates a flowchart of a communication method 1600 implemented at a network device in accordance with some embodiments of the present disclosure. For the purpose of discussion, the method 1600 will be described from the perspective of the network device 120 in FIG. 1B.

At block 1610, the network device transmits, to a terminal device, a configuration for at least reporting information concerning a management of an AI/ML model. The configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset.

At block 1610, the network device receives, from the terminal device, the information based on the configuration.

In some example embodiments, the configuration is further used for reporting a result for a measurement and the parameters of the plurality of levels further comprises at least one of the following: one or more parameters of a fourth level indicating a resource for the terminal device to perform the measurement, or one or more parameters of a fifth level indicating a scheme for reporting the information and the result.

In some example embodiments, the AI/ML model comprises a first part for using by the terminal device and a second part for using by the network device, and the configuration indicates model interference. The network device may receive, from the terminal device, a second result and a first difference between a third result and a first result for a measurement, wherein the first result is obtained by measuring on a first resource indicated by the configuration, the second result is generated based on the first result by using the first part, and the third result is generated based on the second result by using a terminal version of the second part; and generate a fourth result based on the second result by using a network version of the second part; and obtain a fifth result based on the fourth result and the first difference.

In some example embodiments, the AI/ML model comprises a first part for using by the terminal device and a second part for using by the network device, and the configuration indicates model monitoring. The network device may receive, from the terminal device, at least a second difference between a seventh result and a sixth result for a measurement, wherein the sixth result is obtained by measuring a second resource indicated by the configuration, and the seventh result is generated based on the sixth result by using the first part and a terminal version of the second part.

In some example embodiments, the AI/ML model comprises a first part for using by the terminal device and a second part for using by the network device, and the configuration indicates model monitoring. The network device may receive, from the terminal device, a sixth result for a measurement and an eighth result, wherein the sixth result is obtained by measuring a second resource indicated by the configuration and the eighth result is generated based on the sixth result by using the first part; generate a ninth result based on the eight result by using a network version of the second part; and determine a third difference between the sixth and ninth results.

In some example embodiments, the AI/ML model comprises a first part for using by the terminal device and a second part for using by the network device, and the configuration indicates model training. The network device may receive a forward propagation result from the terminal device, the forward propagation result generated based on a training sample by using the first part; generate a backward propagation result based on the forward propagation result and the training sample by using the second part; and transmit the backward propagation result to the terminal device.

In some example embodiments, the AI/ML model comprises a first part for using by the terminal device and a second part for using by the network device, and the configuration indicates model training. The network device may train the second part and a network version of the first part; transmit, to the terminal device, first training information concerning the first part; receive, from the terminal device, information concerning a terminal version of the first part trained based on the first training information; and update, based on the terminal version, at least one of the second part and the network version of the first part.

In some example embodiments, the AI/ML model comprises a first part for using by the terminal device and a second part for using by the network device, and the configuration indicates model training. The network device may receive, from the terminal device, second training information concerning the second part; train a network version of the second part based on the second training information; and transmit information concerning the network version of the second part to the terminal device.

In some example embodiments, the configuration comprises an indication to select at least one of a first component of the AI/ML model or a second component of the AI/ML model, the first component is used by the terminal device, and the second component is used by the network device.

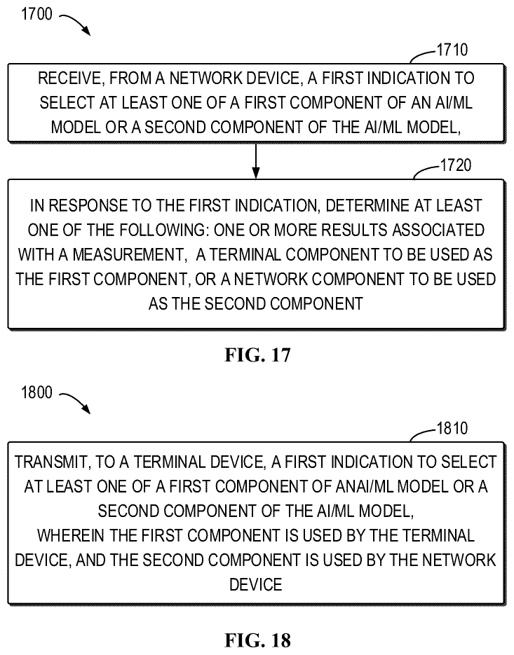

FIG. 17 illustrates a flowchart of a communication method 1700 implemented at a terminal device in accordance with some embodiments of the present disclosure. For the purpose of discussion, the method 1700 will be described from the perspective of the terminal device 110 in FIG. 1B.

At block 1710, the terminal device receives from a network device, a first indication to select at least one of a first component of an AI/ML model or a second component of the AI/ML model, wherein the first component is used by the terminal device, and the second component is used by the network device.

At block 1720, in response to the first indication, the terminal device determines at least one of the following: one or more results associated with a measurement, a terminal component to be used as the first component, or a network component to be used as the second component.

In some example embodiments, the terminal device may in response to the first indication indicating that the terminal component is to be selected for using with the second component, obtain a first result for a measurement by measuring a resource; and generate a plurality of second results based on the first result by using a plurality of terminal components, respectively, wherein the plurality of terminal components are candidates for the first component.

In some example embodiments, the terminal device may transmit the first result and the plurality of second results to the network device; and receive, from the network device, a second indication of the terminal component of the plurality of terminal components to be used as the first component.

In some example embodiments, the terminal device may transmit, to the network device, first information concerning the plurality of terminal components for generating the plurality of second results.

In some example embodiments, the terminal device may in response to the first indication indicating that a network component is to be selected for using with the first component, obtain a first result for a measurement by measuring a resource; and generate a second result based on the first result by using the first component.

In some example embodiments, the terminal device may transmit the first and second results to the network device.

In some example embodiments, the terminal device may transmit, to the network device, second information concerning the first component for generating the second result.

In some example embodiments, the terminal device may in response to the first indication indicating the terminal device to report the network component, obtain a first result for a measurement by measuring a resource; determine a plurality of combinations of terminal and network components based on a plurality of network components and a plurality of terminal components, wherein the plurality of terminal components are candidates for the first component and the plurality of network components are candidates for the second component; generate a plurality of third results based on the first result by using the plurality of combinations, respectively; select the network component from the plurality of network components and the terminal component from the plurality of terminal components based on a comparison of the plurality of third results and the first result; and transmit, to the network device, third information concerning the selected network component.

In some example embodiments, the terminal device may transmit, to the network device, a third result generated by using a combination of the selected terminal component and the selected network component.

In some example embodiments, the terminal device may transmit, to the network device, capability information indicating a number of terminal components as candidates for the first component and a number of network components as candidates for the second component, or receive, from the network device, a configuration indicating the number of terminal components and the number of network components.

In some example embodiments, the terminal device may receive, from the network device, first training information concerning the first component; train a terminal version of the first component based on the training information; and transmit information concerning the terminal version of the first component to the network device.

In some example embodiments, the terminal device may train the first component and a terminal version of the second component; transmitting, to the network device, second training information concerning the second component; receive, from the network device, information concerning a network version of the second component trained based on the second training information; and update, based on the network version, at least one of the first component and the terminal version of the second component.

In some example embodiments, the first indication is comprised in a configuration for at least reporting information concerning a management of the AI/ML model, and the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset.

In some example embodiments, the first component comprises a first part for generating an intermediate result from an initial result and the second component comprises a second part for generating a reconstructed result from the intermediate result, or the first component comprises a quantization module for converting values into bits and the second component comprises a dequantization module for converting bits into values.

FIG. 18 illustrates a flowchart of a communication method 1800 implemented at a network device in accordance with some embodiments of the present disclosure. For the purpose of discussion, the method 1800 will be described from the perspective of the network device 120 in FIG. 1B.

At block 1810, the network device transmits, to a terminal device, a first indication to select at least one of a first component of an AI/ML model or a second component of the AI/ML model. The first component is used by the terminal device, and the second component is used by the network device.

In some example embodiments, the first indication indicates that a terminal component to be used as the first component is to be selected for using with the second component.

In some example embodiments, the network device may receive, from the terminal device, a first result for a measurement and a plurality of second results, wherein the first result is obtained by measuring a resource, and the plurality of second results is generated based on the first result by using a plurality of terminal components as candidates for the first component; generate, by using the second component, a plurality of third result based on the plurality of second results, respectively; select a terminal component from the plurality of terminal components based on a comparison of the first result and the plurality of third results; and transmit, to the terminal device, a second indication of the selected terminal component.

In some example embodiments, the network device may receive, from the terminal device, first information concerning the plurality of terminal components for generating the plurality of second results.

In some example embodiments, the first indication indicates that a network component to be used as the second component is to be selected for using with the first component.

In some example embodiments, the network device may receive, from the terminal device, a first result for a measurement and a second result, wherein the first result is obtained by measuring a resource, and the second result is generated based on the first result by using the first component; generate a plurality of third results based on the second result by using a plurality of network components, respectively, wherein the plurality of network components are candidates for the second component; and select, based on a comparison of the first result and the plurality of third results, a network component from the plurality of network components to be used as the second component.

In some example embodiments, the network device may receive, from the terminal device, second information concerning the first component for generating the second result.

In some example embodiments, the first indication indicates the terminal device to report a network component to be used as the second component, and the method further comprises: receiving, from the terminal device, third information concerning the network component selected as the second component.

In some example embodiments, the network device may receive, from the terminal device, a third result generated by using a combination of the network component and a terminal component selected as the first component.

In some example embodiments, the network device may receive, from the terminal device, capability information indicating a number of terminal components as candidates for the first component and a number of network components as candidates for the second component, or transmit, to the terminal device, a configuration indicating the number of terminal components and the number of network components.

In some example embodiments, the network device may train the second component and a network version of the first component; transmitting, to the terminal device, first training information concerning the first component; receive, from the terminal device, information concerning a terminal version of the first component trained based on the first training information; and update, based on the terminal version, at least one of the second component and the network version of the first component.

In some example embodiments, the network device may receive, from the terminal device, second training information concerning the second component; train a network version of the second component based on the second training information; and transmit information concerning the network version of the second component to the terminal device.

In some example embodiments, the first indication is comprised in a configuration for at least reporting information concerning a management of the AI/ML model, and the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset.

In some example embodiments, the first component comprises a first part for generating an intermediate result from an initial result and the second component comprises a second part for generating a reconstructed result from the intermediate result, or the first component comprises a quantization module for converting values into bits and the second component comprises a dequantization module for converting bits into values.

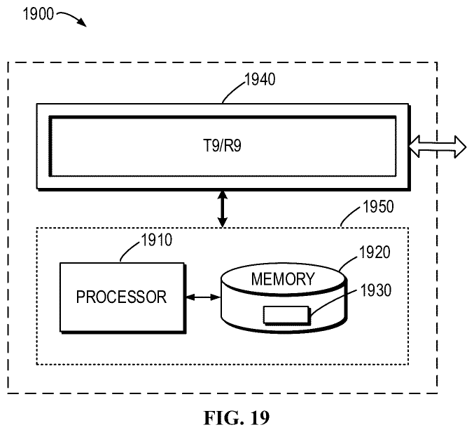

FIG. 19 is a simplified block diagram of a device 1900 that is suitable for implementing embodiments of the present disclosure. The device 1900 can be considered as a further example implementation of any of the devices as shown in FIG. 1B. Accordingly, the device 1900 can be implemented at or as at least a part of the terminal device 110 or the network device 120.

As shown, the device 1900 includes a processor 1910, a memory 1920 coupled to the processor 1910, a suitable transmitter (TX)/receiver (RX) 1940 coupled to the processor 1910, and a communication interface coupled to the TX/RX 1940. The memory 1910 stores at least a part of a program 1930. The TX/RX 1940 is for bidirectional communications. The TX/RX 1940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1930 is assumed to include program instructions that, when executed by the associated processor 1910, enable the device 1900 to operate in accordance with the embodiments of the present disclosure, as discussed herein with reference to FIGS. 4A to 18. The embodiments herein may be implemented by computer software executable by the processor 1910 of the device 1900, or by hardware, or by a combination of software and hardware. The processor 1910 may be configured to implement various embodiments of the present disclosure. Furthermore, a combination of the processor 1910 and memory 1920 may form processing means 1950 adapted to implement various embodiments of the present disclosure.

The memory 1920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1920 is shown in the device 1900, there may be several physically distinct memory modules in the device 1900. The processor 1910 may be of any type suitable to the local technical network, and may include one or more of general purpose computers, special purpose computers, microprocessors, digital signal processors (DSPs) and processors based on multicore processor architecture, as non-limiting examples. The device 1900 may have multiple processors, such as an application specific integrated circuit chip that is slaved in time to a clock which synchronizes the main processor.

In some embodiments, a terminal device comprises a circuitry configured to: receive, from a network device, a configuration for at least reporting information concerning a management of an artificial intelligence/machine learning (AI/ML) model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and transmit, to the network device, the information based on the configuration. According to embodiments of the present disclosure, the circuitry may be configured to perform any of the method implemented by the network device as discussed above.

In some embodiments, a network device comprises a circuitry configured to: transmit, to a terminal device, a configuration for at least reporting information concerning a management of an artificial intelligence/machine learning (AI/ML) model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and receive, from the terminal device, the information based on the configuration. According to embodiments of the present disclosure, the circuitry may be configured to perform any of the method implemented by the network device as discussed above.

In some embodiments, a terminal device comprises a circuitry configured to: receive, from a network device, a first indication to select at least one of a first component of an artificial intelligence/machine learning (AI/ML) model or a second component of the AI/ML model, wherein the first component is used by the terminal device, and the second component is used by the network device; and in response to the first indication, determine at least one of the following: one or more results associated with a measurement, a terminal component to be used as the first component, or a network component to be used as the second component. According to embodiments of the present disclosure, the circuitry may be configured to perform any of the method implemented by the network device as discussed above.

In some embodiments, a network device comprises a circuitry configured to: transmit, at a network device, to a terminal device, a first indication to select at least one of a first component of an artificial intelligence/machine learning (AI/ML) model or a second component of the AI/ML model, wherein the first component is used by the terminal device, and the second component is used by the network device. According to embodiments of the present disclosure, the circuitry may be configured to perform any of the method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In a first aspect, a terminal device comprises: a processor configured to cause the terminal device to: receive, from a network device, a configuration for at least reporting information concerning a management of an artificial intelligence/machine learning (AI/ML) model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and transmit, to the network device, the information based on the configuration.

In some embodiments, the configuration is further used for reporting a result for a measurement and the parameters of the plurality of levels further comprise at least one of the following: one or more parameters of a fourth level indicating a resource for the terminal device to perform the measurement, or one or more parameters of a fifth level of parameters indicating a scheme for reporting the information and the result.

In some embodiments, the AI/ML model comprises a first part for using by the terminal device and a second part for using by the network device, and the configuration indicates model interference, and the processor is further configured to cause the terminal device to: obtain a first result for a measurement by measuring on a first resource indicated by the configuration; generate a second result based on the first result by using the first part; generate a third result based on the second result by using a terminal version of the second part; and transmit, to the network device, the second result and a first difference between the first and third results.

In some embodiments, the AI/ML model comprises a first part for using by the terminal device and a second part for using by the network device, and the configuration indicates model monitoring, and the processor is further configured to cause the terminal device to: obtain a sixth result for a measurement by measuring a second resource indicated by the configuration; generate a seventh result based on the sixth result by using the first part and a terminal version of the second part; and transmit, to the network device, at least a second difference between the sixth and seventh results.

In some embodiments, the AI/ML model comprises a first part for using by the terminal device and a second part for using by the network device, and the configuration indicates model monitoring, and the processor is further configured to cause the terminal device to: obtain a sixth result for a measurement by measuring a second resource indicated by the configuration; generate an eighth result based on the sixth result by using the first part; and transmit the sixth and eighth results to the network device.

In some embodiments, the AI/ML model comprises a first part for using by the terminal device and a second part for using by the network device, and the configuration indicates model training, and the processor is further configured to cause the terminal device to: generate a forward propagation result based on a training sample by using the first part; transmit the forward propagation result to the network device; receive a backward propagation result from the network device, the backward propagation result generated based on the forward propagation result and the training sample by using the second part; and update the first part based on the backward propagation result.

In some embodiments, the AI/ML model comprises a first part for using by the terminal device and a second part for using by the network device, and the configuration indicates model training, and the processor is further configured to cause the terminal device to: receive, from the network device, first training information concerning the first part; train a terminal version of the first part based on the training information; and transmit information concerning the terminal version of the first part to the network device.

In some embodiments, the AI/ML model comprises a first part for using by the terminal device and a second part for using by the network device, and the configuration indicates model training, and the processor is further configured to cause the terminal device to: train the first part and a terminal version of the second part; transmit, to the network device, second training information concerning the second part; receive, from the network device, information concerning a network version of the second part trained based on the second training information; and update, based on the network version, at least one of the first part and the terminal version of the second part.

In some embodiments, the configuration comprises an indication to select at least one of a first component of the AI/ML model or a second component of the AI/ML model, the first component is used by the terminal device, and the second component is used by the network device.

In a second aspect, a network device comprises: a processor configured to cause the network device to: transmit, to a terminal device, a configuration for at least reporting information concerning a management of an artificial intelligence/machine learning (AI/ML) model, wherein the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset; and receive, from the terminal device, the information based on the configuration.

In some embodiments, the configuration is further used for reporting a result for a measurement and the parameters of the plurality of levels further comprises at least one of the following: one or more parameters of a fourth level indicating a resource for the terminal device to perform the measurement, or one or more parameters of a fifth level indicating a scheme for reporting the information and the result.

In some embodiments, the AI/ML model comprises a first part for using by the terminal device and a second part for using by the network device, and the configuration indicates model interference, and the processor is further configured to cause the network device to: receive, from the terminal device, a second result and a first difference between a third result and a first result for a measurement, wherein the first result is obtained by measuring on a first resource indicated by the configuration, the second result is generated based on the first result by using the first part, and the third result is generated based on the second result by using a terminal version of the second part; and generate a fourth result based on the second result by using a network version of the second part; and obtain a fifth result based on the fourth result and the first difference.

In some embodiments, the AI/ML model comprises a first part for using by the terminal device and a second part for using by the network device, and the configuration indicates model monitoring, and the processor is further configured to cause the network device to: receive, from the terminal device, at least a second difference between a seventh result and a sixth result for a measurement, wherein the sixth result is obtained by measuring a second resource indicated by the configuration, and the seventh result is generated based on the sixth result by using the first part and a terminal version of the second part.

In some embodiments, the AI/ML model comprises a first part for using by the terminal device and a second part for using by the network device, and the configuration indicates model monitoring, and the processor is further configured to cause the network device to: receive, from the terminal device, a sixth result for a measurement and an eighth result, wherein the sixth result is obtained by measuring a second resource indicated by the configuration and the eighth result is generated based on the sixth result by using the first part; generate a ninth result based on the eight result by using a network version of the second part; and determine a third difference between the sixth and ninth results.

In some embodiments, the AI/ML model comprises a first part for using by the terminal device and a second part for using by the network device, and the configuration indicates model training, and the processor is further configured to cause the network device to: receive a forward propagation result from the terminal device, the forward propagation result generated based on a training sample by using the first part; generate a backward propagation result based on the forward propagation result and the training sample by using the second part; and transmit the backward propagation result to the terminal device.

In some embodiments, the AI/ML model comprises a first part for using by the terminal device and a second part for using by the network device, and the configuration indicates model training, and the processor is further configured to cause the network device to: train the second part and a network version of the first part; transmit, to the terminal device, first training information concerning the first part; receive, from the terminal device, information concerning a terminal version of the first part trained based on the first training information; and update, based on the terminal version, at least one of the second part and the network version of the first part.

In some embodiments, the AI/ML model comprises a first part for using by the terminal device and a second part for using by the network device, and the configuration indicates model training, and the processor is further configured to cause the network device to: receive, from the terminal device, second training information concerning the second part; train a network version of the second part based on the second training information; and transmit information concerning the network version of the second part to the terminal device.

In some embodiments, the configuration comprises an indication to select at least one of a first component of the AI/ML model or a second component of the AI/ML model, the first component is used by the terminal device, and the second component is used by the network device.

In a third aspect, a terminal device comprises: a processor configured to cause the terminal device to: receive, from a network device, a first indication to select at least one of a first component of an artificial intelligence/machine learning (AI/ML) model or a second component of the AI/ML model, wherein the first component is used by the terminal device, and the second component is used by the network device; and in response to the first indication, determine at least one of the following: one or more results associated with a measurement, a terminal component to be used as the first component, or a network component to be used as the second component.

In some embodiments, the processor is further configured to cause the terminal device to: in response to the first indication indicating that the terminal component is to be selected for using with the second component, obtain a first result for a measurement by measuring a resource; and generate a plurality of second results based on the first result by using a plurality of terminal components, respectively, wherein the plurality of terminal components are candidates for the first component.

In some embodiments, the processor is further configured to cause the terminal device to: transmit the first result and the plurality of second results to the network device; and receive, from the network device, a second indication of the terminal component of the plurality of terminal components to be used as the first component.

In some embodiments, the processor is further configured to cause the terminal device to: transmit, to the network device, first information concerning the plurality of terminal components for generating the plurality of second results.

In some embodiments, the processor is further configured to cause the terminal device to: in response to the first indication indicating that a network component is to be selected for using with the first component, obtain a first result for a measurement by measuring a resource; and generate a second result based on the first result by using the first component.

In some embodiments, the processor is further configured to cause the terminal device to: transmit the first and second results to the network device.

In some embodiments, the processor is further configured to cause the terminal device to: transmit, to the network device, second information concerning the first component for generating the second result.

In some embodiments, the processor is further configured to cause the terminal device to: in response to the first indication indicating the terminal device to report the network component, obtain a first result for a measurement by measuring a resource; determine a plurality of combinations of terminal and network components based on a plurality of network components and a plurality of terminal components, wherein the plurality of terminal components are candidates for the first component and the plurality of network components are candidates for the second component; generate a plurality of third results based on the first result by using the plurality of combinations, respectively; select the network component from the plurality of network components and the terminal component from the plurality of terminal components based on a comparison of the plurality of third results and the first result; and transmit, to the network device, third information concerning the selected network component.

In some embodiments, the processor is further configured to cause the terminal device to: transmit, to the network device, a third result generated by using a combination of the selected terminal component and the selected network component.

In some embodiments, the processor is further configured to cause the terminal device to perform at least one of the followings: transmitting, to the network device, capability information indicating a number of terminal components as candidates for the first component and a number of network components as candidates for the second component, or receiving, from the network device, a configuration indicating the number of terminal components and the number of network components.

In some embodiments, the processor is further configured to cause the terminal device to: receive, from the network device, first training information concerning the first component; train a terminal version of the first component based on the training information; and transmit information concerning the terminal version of the first component to the network device.

In some embodiments, the processor is further configured to cause the terminal device to: train the first component and a terminal version of the second component; transmit, to the network device, second training information concerning the second component; receive, from the network device, information concerning a network version of the second component trained based on the second training information; and update, based on the network version, at least one of the first component and the terminal version of the second component.

In some embodiments, the first indication is comprised in a configuration for at least reporting information concerning a management of the AI/ML model, and the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset.

In some embodiments, the first component comprises a first part for generating an intermediate result from an initial result and the second component comprises a second part for generating a reconstructed result from the intermediate result, or the first component comprises a quantization module for converting values into bits and the second component comprises a dequantization module for converting bits into values.

In a fourth aspect, a network device comprises: a processor configured to cause the network device to: transmit, to a terminal device, a first indication to select at least one of a first component of an artificial intelligence/machine learning (AI/ML) model or a second component of the AI/ML model, wherein the first component is used by the terminal device, and the second component is used by the network device.

In some embodiments, the first indication indicates that a terminal component to be used as the first component is to be selected for using with the second component.

In some embodiments, the processor is further configured to cause the network device to: receive, from the terminal device, a first result for a measurement and a plurality of second results, wherein the first result is obtained by measuring a resource, and the plurality of second results is generated based on the first result by using a plurality of terminal components as candidates for the first component; generate, by using the second component, a plurality of third result based on the plurality of second results, respectively; select a terminal component from the plurality of terminal components based on a comparison of the first result and the plurality of third results; and transmit, to the terminal device, a second indication of the selected terminal component.

In some embodiments, the processor is further configured to cause the network device to: receive, from the terminal device, first information concerning the plurality of terminal components for generating the plurality of second results.

In some embodiments, the first indication indicates that a network component to be used as the second component is to be selected for using with the first component.

In some embodiments, the processor is further configured to cause the network device to: receive, from the terminal device, a first result for a measurement and a second result, wherein the first result is obtained by measuring a resource, and the second result is generated based on the first result by using the first component; generate a plurality of third results based on the second result by using a plurality of network components, respectively, wherein the plurality of network components are candidates for the second component; and select, based on a comparison of the first result and the plurality of third results, a network component from the plurality of network components to be used as the second component.

In some embodiments, the processor is further configured to cause the network device to: receive, from the terminal device, second information concerning the first component for generating the second result.

In some embodiments, the first indication indicates the terminal device to report a network component to be used as the second component, and the processor is further configured to cause the network device to: receive, from the terminal device, third information concerning the network component selected as the second component.

In some embodiments, the processor is further configured to cause the network device to: receive, from the terminal device, a third result generated by using a combination of the network component and a terminal component selected as the first component.

In some embodiments, the processor is further configured to cause the network device to perform at least one of the followings: receiving, from the terminal device, capability information indicating a number of terminal components as candidates for the first component and a number of network components as candidates for the second component, or transmitting, to the terminal device, a configuration indicating the number of terminal components and the number of network components.

In some embodiments, the processor is further configured to cause the network device to: train the second component and a network version of the first component; transmit, to the terminal device, first training information concerning the first component; receive, from the terminal device, information concerning a terminal version of the first component trained based on the first training information; and update, based on the terminal version, at least one of the second component and the network version of the first component.

In some embodiments, the processor is further configured to cause the network device to: receive, from the terminal device, second training information concerning the second component; trains a network version of the second component based on the second training information; and transmit information concerning the network version of the second component to the terminal device.

In some embodiments, the first indication is comprised in a configuration for at least reporting information concerning a management of the AI/ML model, and the configuration comprises parameters of a plurality of levels, a parameter of a higher level is associated with one or more parameters of a lower level, and the parameters of the plurality of levels comprise two or more of the following: one or more parameters of a first level indicating the AI/ML model, one or more parameters of a second level indicating a stage of the management, or one or more parameters of a third level indicating a dataset.

In some embodiments, the first component comprises a first part for generating an intermediate result from an initial result and the second component comprises a second part for generating a reconstructed result from the intermediate result, or the first component comprises a quantization module for converting values into bits and the second component comprises a dequantization module for converting bits into values.

In an aspect, a computer readable medium having instructions stored thereon, the instructions, when executed on at least one processor, causing the at least one processor to perform the method implemented by the terminal device discussed above.

In an aspect, a computer readable medium having instructions stored thereon, the instructions, when executed on at least one processor, causing the at least one processor to perform the method implemented by the network device discussed above.

In an aspect, a computer program comprising instructions, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 19. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
a processor configured to cause the terminal device to:
receive, from a network device, a configuration for at least reporting information concerning a management of an artificial intelligence/machine learning (AI/ML) model,
wherein the configuration comprises parameters of a plurality of levels, a parameter of a higher level is associated with one or more parameters of a lower level, and the parameters of the plurality of levels comprise two or more of the following:
one or more parameters of a first level indicating the AI/ML model,
one or more parameters of a second level indicating a stage of the management, or
one or more parameters of a third level indicating a dataset; and
transmit, to the network device, the information based on the configuration.

2. The device of claim 1, wherein the AI/ML model comprises a first part for using by the terminal device and a second part for using by the network device, and the configuration indicates model interference, and
the processor is further configured to cause the terminal device to:
obtain a first result for a measurement by measuring on a first resource indicated by the configuration;
generate a second result based on the first result by using the first part;
generate a third result based on the second result by using a terminal version of the second part; and
transmit, to the network device, the second result and a first difference between the first and third results.

3. The device of claim 1, wherein the AI/ML model comprises a first part for using by the terminal device and a second part for using by the network device, and the configuration indicates model monitoring, and
the processor is further configured to cause the terminal device to:
obtain a sixth result for a measurement by measuring a second resource indicated by the configuration;
generate a seventh result based on the sixth result by using the first part and a terminal version of the second part; and
transmit, to the network device, at least a second difference between the sixth and seventh results.

4. The device of claim 1, wherein the AI/ML model comprises a first part for using by the terminal device and a second part for using by the network device, and the configuration indicates model monitoring, and
the processor is further configured to cause the terminal device to:
obtain a sixth result for a measurement by measuring a second resource indicated by the configuration;
generate an eighth result based on the sixth result by using the first part; and
transmit the sixth and eighth results to the network device.

5. The device of claim 1, wherein the AI/ML model comprises a first part for using by the terminal device and a second part for using by the network device, and the configuration indicates model training, and
the processor is further configured to cause the terminal device to:
receive, from the network device, first training information concerning the first part;
train a terminal version of the first part based on the training information; and
transmit information concerning the terminal version of the first part to the network device.

6. The device of claim 1, wherein the AI/ML model comprises a first part for using by the terminal device and a second part for using by the network device, and the configuration indicates model training, and
the processor is further configured to cause the terminal device to:
train the first part and a terminal version of the second part;
transmit, to the network device, second training information concerning the second part;
receive, from the network device, information concerning a network version of the second part trained based on the second training information; and
update, based on the network version, at least one of the first part and the terminal version of the second part.

7. The device of claim 1, wherein the configuration comprises an indication to select at least one of a first component of the AI/ML model or a second component of the AI/ML model, the first component is used by the terminal device, and the second component is used by the network device.

8. A network device comprising:
a processor configured to cause the network device to:
transmit, to a terminal device, a configuration for at least reporting information concerning a management of an artificial intelligence/machine learning (AI/ML) model,
wherein the configuration comprises parameters of a plurality of levels, a parameter of a higher level is associated with one or more parameters of a lower level, and the parameters of the plurality of levels comprise two or more of the following:
one or more parameters of a first level indicating the AI/ML model,
one or more parameters of a second level indicating a stage of the management, or
one or more parameters of a third level indicating a dataset; and
receive, from the terminal device, the information based on the configuration.

9. A terminal device comprising:
a processor configured to cause the terminal device to:
receive, from a network device, a first indication to select at least one of a first component of an artificial intelligence/machine learning (AI/ML) model or a second component of the AI/ML model, wherein the first component is used by the terminal device, and the second component is used by the network device; and
in response to the first indication, determine at least one of the following:
one or more results associated with a measurement,
a terminal component to be used as the first component, or
a network component to be used as the second component.

10. The device of claim 9, wherein the processor is further configured to cause the terminal device to:
in response to the first indication indicating that the terminal component is to be selected for using with the second component,
obtain a first result for a measurement by measuring a resource; and
generate a plurality of second results based on the first result by using a plurality of terminal components, respectively, wherein the plurality of terminal components are candidates for the first component.

11. The device of claim 10, wherein the processor is further configured to cause the terminal device to:
transmit the first result and the plurality of second results to the network device; and
receive, from the network device, a second indication of the terminal component of the plurality of terminal components to be used as the first component.

12. The device of claim 11, wherein the processor is further configured to cause the terminal device to:
transmit, to the network device, first information concerning the plurality of terminal components for generating the plurality of second results.

13. The device of claim 9, wherein the processor is further configured to cause the terminal device to:
in response to the first indication indicating that a network component is to be selected for using with the first component,
obtain a first result for a measurement by measuring a resource; and
generate a second result based on the first result by using the first component.

14. The device of claim 13, wherein the processor is further configured to cause the terminal device to:
transmit the first and second results to the network device.

15. The device of claim 14, wherein the processor is further configured to cause the terminal device to:
transmit, to the network device, second information concerning the first component for generating the second result.

16. The device of claim 9, wherein the processor is further configured to cause the terminal device to:
in response to the first indication indicating the terminal device to report the network component,
obtain a first result for a measurement by measuring a resource;
determine a plurality of combinations of terminal and network components based on a plurality of network components and a plurality of terminal components, wherein the plurality of terminal components are candidates for the first component and the plurality of network components are candidates for the second component;
generate a plurality of third results based on the first result by using the plurality of combinations, respectively;
select the network component from the plurality of network components and the terminal component from the plurality of terminal components based on a comparison of the plurality of third results and the first result; and
transmit, to the network device, third information concerning the selected network component.

17. The device of claim 9, wherein the processor is further configured to cause the terminal device to perform at least one of the followings:
transmitting, to the network device, capability information indicating a number of terminal components as candidates for the first component and a number of network components as candidates for the second component, or
receiving, from the network device, a configuration indicating the number of terminal components and the number of network components.

18. The device of claim 9, wherein the first component comprises a first part for generating an intermediate result from an initial result and the second component comprises a second part for generating a reconstructed result from the intermediate result, or
the first component comprises a quantization module for converting values into bits and the second component comprises a dequantization module for converting bits into values.

19. A network device comprising:
a processor configured to cause the network device to:
transmit, to a terminal device, a first indication to select at least one of a first component of an artificial intelligence/machine learning (AI/ML) model or a second component of the AI/ML model,
wherein the first component is used by the terminal device, and the second component is used by the network device.

20. The device of claim 19, wherein the first component comprises a first part for generating an intermediate result from an initial result and the second component comprises a second part for generating a reconstructed result from the intermediate result, or
the first component comprises a quantization module for converting values into bits and the second component comprises a dequantization module for converting bits into values.
